(19) United States
(12) Patent Application Publication
(10) Pub. No.: US 2026/0347231 A1
(43) Pub. Date: Nov. 5, 2026

(54) GLASS TUBES WITH DOME-SHAPED ENDS

(71) Applicant: CORNING INCORPORATED, CORNING, NY (US)

(72) Inventor: Jay William Spike, Painted Post, NY (US)

(21) Appl. No.: 19/487,332

(22) PCT Filed: May 24, 2024
(86) PCT No.: PCT/US2024/030912

§ 371 Date: Nov. 24, 2025

Related U.S. Application Data
(60) Provisional application No. 63/470,230, filed on Jun. 1, 2023.

(51) Int. Cl. C03B 23/09; C03B 35/26

(52) U.S. Cl. CPC C03B 23/09; C03B 35/26

(57) ABSTRACT

Glass tubes including a first end, a second end, and a hollow cylindrical sidewall comprising a glass and having an outer diameter d₁, wherein the first end, the second end, or both comprise a dome end glaze comprising the glass and having an outer surface with a convex shape. Methods of finishing an end of a glass tube include rotating the glass tube about a center axis of the glass tube, removing an annular segment of the glass tube from a starting end of the glass tube while concurrently forming a meniscus of glass over a new end of the glass tube, and polishing the meniscus of glass at the new end of the glass tube to form a dome end glaze at the new end of the glass tube, wherein the dome end glaze comprises an outer surface having a convex shape.

### CROSS-REFERENCE TO RELATED APPLICATIONS

This application claims the benefit of priority under 35 U.S.C. § 119 of U.S. Provisional Application Ser. No. 63/470,230 filed on Jun. 1, 2023, the content of which is relied upon and incorporated herein by reference in its entirety.

### TECHNICAL FIELD

The present specification generally relates to glass tubes and, more specifically, to glass tubes having dome-shaped ends and methods of manufacturing the same.

### BACKGROUND

Historically, glass has been used to produce a variety of articles. For example, because of its hermeticity, optical clarity, and excellent chemical durability relative to other materials, glass has been a preferred material for pharmaceutical applications, including, without limitation, vials, syringes, ampoules, cartridges, and other glass articles. Production of these articles from glass starts with providing glass tubing that may subsequently be formed and separated into a plurality of glass articles. Specifically, the glass used in pharmaceutical packaging must have adequate mechanical and chemical durability so as to not affect the stability of the pharmaceutical formulations contained therein. Glasses having suitable chemical durability include those glass compositions within the ASTM standard ‘Type IA’ and ‘Type IB’glass compositions which have a proven history of chemical durability.

The glass tubes used as the starting material for producing glass articles are produced from a continuous process, such as a Danner or Vello process, for producing a continuous hollow glass cylinder. The continuous hollow glass cylinder is annealed and cut into sections of glass tubes of roughly the same length by a high speed continuous cutter. Following the initial separation of the continuous hollow glass cylinder into a plurality of glass tubes, each of the glass tubes are further processed to finish the ends of the glass tubes, such as by cutting to length and polishing the ends to reduce breakage during shipping and handling. The processing operations involved in finishing the ends of the glass tubes may introduce defects into the glass tubes.

### SUMMARY

According to a first aspect of the present disclosure, a glass tube may comprise a first end, a second end, and a hollow cylindrical sidewall comprising a glass and having an outer diameter d₁. The first end, the second end, or both may comprise a dome end glaze comprising the glass and having an outer surface with a convex shape. The glass tube may comprise a longitudinal length L greater than or equal to 30 times d₁.

A second aspect may include the first aspect, wherein the longitudinal length L of the glass tube is greater than or equal to 800 mm.

A third aspect may include any one of the first or second aspects, wherein the convex shape of the outer surface of the dome end glaze comprises a radius of curvature r_{c} greater than or equal to 0.4 times d₁ over positions on the convex shape that are within a distance of 0.4 times d₁ from the center axis of the glass tube.

A fourth aspect may include third aspect, wherein the radius of curvature is less than or equal to 0.6 times d₁ over positions on the convex shape that are within a distance of 0.4 times d₁ from the center axis of the glass tube.

A fifth aspect may include any one of the first or second aspects, wherein the dome end glaze comprises a dome height H greater than or equal to 0.4 times d₁.

A sixth aspect may include fifth aspect, wherein the dome height H is less than or equal to 0.6 times d₁.

A seventh aspect may include any one of the first through sixth aspects, wherein the dome end glaze comprises a wall thickness that is less than or equal to a wall thickness of the hollow cylindrical sidewall.

An eighth aspect may include any one of the first through seventh aspects, wherein the dome end glaze covers at least 75% of a cross-sectional area of the glass tube at the first end, the second end, or both.

A ninth aspect may include the eighth aspect, wherein the dome end glaze closes off the glass tube at the first end of the glass tube, the second end of the glass tube, or both.

A tenth aspect may include the eighth aspect, wherein the dome end glaze comprises a vent hole.

An eleventh aspect may include the tenth aspect, wherein the vent hole is aligned with a center axis of the glass tube.

A twelfth aspect may include the tenth aspect, wherein a center line of the vent hole makes an angle with a center axis of the glass tube that is less than 90 degrees, less than 70 degrees, or less than 45 degrees.

A thirteenth aspect may include the tenth aspect, wherein a center line of the vent hole is not perpendicular to a center axis of the glass tube.

A fourteenth aspect may include any one of the tenth through thirteenth aspects, wherein the vent hole comprises a diameter of between 0.05 times d₁ and 0.20 times d₁.

A fifteenth aspect may include any one of the first through fourteenth aspects, wherein the glass tube is substantially free of end cracks and inclusions.

A sixteenth aspect may include any one of the first through fifteenth aspects, wherein the glass tube is substantially free of glass particulates fused to outer surfaces and inner surfaces of the hollow cylindrical sidewall.

A seventeenth aspect may include any one of the first through sixteenth aspects, wherein the dome end glaze comprises a first dome end glaze at the first end of the glass tube and a second dome end glaze at the second end of the glass tube.

According to an eighteenth aspect of the present disclosure, a method of finishing an end of a glass tube may include rotating the glass tube about a center axis of the glass tube; removing an annular segment of the glass tube from a starting end of the glass tube, wherein removing the annular segment from the starting end of the glass tube forms a meniscus of glass over a new end of the glass tube; and polishing the meniscus of glass at the new end of the glass tube to form a dome end glaze at the new end of the glass tube, wherein the dome end glaze comprises an outer surface having a convex shape. The glass tube may comprise a longitudinal length L greater than or equal to 30 times d₁, where d₁ is an outer diameter of the glass tube.

A nineteenth aspect may include the eighteenth aspect, wherein the longitudinal length L of the glass tube is greater than or equal to 800 mm.

A twentieth aspect may include any one of the eighteenth or nineteenth aspects, wherein the convex shape of the outer surface of the dome end glaze comprises a radius of curvature r_{c} greater than or equal to 0.4 times d₁ over positions on the convex shape that are within a distance of 0.4 times d₁ from the center axis of the glass tube.

A twenty-first aspect may include the twentieth aspect, wherein the radius of curvature r_{c} is less than or equal to 0.6 times d₁ over positions on the convex shape that are within a distance of 0.4 times d₁ from the center axis of the glass tube.

A twenty-second aspect may include any one of the eighteenth or nineteenth aspects, wherein the dome end glaze comprises a dome height H greater than or equal to 0.4 times d₁.

A twenty-third aspect may include the twenty-second aspect, wherein the dome height H is less than or equal to 0.6 times d₁.

A twenty-fourth aspect may include any one of the eighteenth through twenty-third aspects, wherein removing the annular segment from the starting end of the glass tube comprises: heating a target region of the glass tube proximate the starting end of the glass tube; and conveying the annular segment of the glass tube away from the glass tube in a direction parallel to the center axis of the glass tube.

A twenty-fifth aspect may include the twenty-fourth aspect, wherein heating the target region of the glass tube comprises heating the glass tube circumferentially as the glass tube rotates, and wherein the target region less than or equal to 50 mm from the starting end of the glass tube.

A twenty-sixth aspect may include any one of the twenty-fourth or twenty-fifth aspects, wherein conveying the annular segment of the glass tube away from the glass tube comprises contacting the starting end of the glass tube with a roller having a roller axis of rotation that makes an angle with the center axis of the glass tube that is between 10 degrees and 80 degrees, wherein contacting the starting end of the glass tube with the roller exerts an axial pulling force on the starting end of the glass tube, and wherein the axial pulling force separates the annular segment from the glass tube.

A twenty-seventh aspect may include any one of the eighteenth through twenty-sixth aspects, wherein polishing the meniscus of glass at the new end of the glass tube comprises exposing the meniscus of glass at the new end of the glass tube to a gas burner to flame polish the meniscus of glass at the new end of the glass tube.

A twenty-eighth aspect may include any one of the eighteenth through twenty-seventh aspects, wherein finishing the end of the glass tube produces the glass tube substantially free of end cracks and inclusions.

A twenty-ninth aspect may include any one of the eighteenth through twenty-eighth aspects, wherein finishing the end of the glass tube produces the glass tube substantially free of glass particulates fused to outer surfaces or inner surfaces of the glass tube.

A thirtieth aspect may include any one of the eighteenth through twenty-ninth aspects, further comprising forming a vent hole in the dome end glaze.

A thirty-first aspect may include the thirtieth aspect, wherein forming the vent hole in the dome end glaze comprises opening the dome end glaze at a position aligned with the center axis of the glass tube.

A thirty-second aspect may include any one of the thirtieth or thirty-first aspects, wherein forming the vent hole in the dome end glaze comprises exposing the dome end glaze to a vent hole burner to melt and open the dome end glaze.

A thirty-third aspect may include any one of the eighteenth through thirty-second aspects, further comprising forming the meniscus to modify the convex shape of the dome end glaze.

A thirty-fourth aspect may include the thirty-third aspect, wherein forming the meniscus comprises contacting the meniscus with a forming tool that reshapes the meniscus.

A thirty-fifth aspect may include any one of the eighteenth through thirty-fourth aspects, wherein the method comprises finishing a first and a second end of the glass tube by: removing a first annular segment of the glass tube from a first starting end of the glass tube, wherein removing the first annular segment from the first starting end of the glass tube forms a first meniscus of glass over a first new end of the glass tube; polishing the first meniscus of glass and the first new end of the glass tube to form a first dome end glaze at the first new end of the glass tube; removing a second annular segment of the glass tube from a second starting end of the glass tube, wherein removing the second annular segment from the second starting end of the glass tube forms a second meniscus of glass over a second new end of the glass tube; and polishing the second meniscus of glass and the second new end of the glass tube to form a second dome end glaze at the second new end of the glass tube, wherein the first dome end glaze comprises a first outer surface having a first convex shape and the second dome end glaze comprises an second outer surface having a second convex shape.

A thirty-sixth aspect may include any one of the eighteenth through thirty-fifth aspects, further comprising forming the meniscus to modify the convex shape of the dome end glaze.

According to a thirty-seventh aspect of the present disclosure, a system for finishing an end of a glass tube may include a conveyor configured to translate the glass tube and to rotate the glass tube about a center axis of the glass tube, the glass tube comprising a longitudinal length L greater than or equal to 30 times d₁, where d₁ is an outer diameter of the glass tube; a separating station configured to remove an annular segment of the glass tube from a starting end of the glass tube, wherein removing the annular segment from the starting end of the glass tube forms a meniscus of glass over a new end of the glass tube; and a polishing station configured to shape the meniscus of glass at the new end of the glass tube to form a dome end glaze at the new end of the glass tube, wherein the dome end glaze comprises an outer surface having a convex shape

A thirty-eighth aspect may include the thirty-seventh aspect, wherein the conveyor comprises a plurality of conveying rollers configured to translate the glass tube in a direction perpendicular to the center axis of the glass tube.

A thirty-ninth aspect may include any one of the thirty-seventh or thirty-eighth aspects, wherein the convex shape of the outer surface of the dome end glaze comprises a radius of curvature r_{c} greater than or equal to 0.4 times d₁ over positions on the convex shape that are within a distance of 0.4 times d₁ from the center axis of the glass tube.

A fortieth aspect may include the thirty-ninth aspect, wherein the radius of curvature r_{c} is less than or equal to 0.6 times d₁ over positions on the convex shape that are within a distance of 0.4 times d₁ from the center axis of the glass tube.

A forty-first aspect may include any one of the thirty-seventh or thirty-eighth aspects, wherein the dome end glaze comprises a dome height H greater than or equal to 0.4 times d₁.

A forty-second aspect may include the forty-second aspect, wherein the dome height H is less than or equal to 0.6 times d₁.

A forty-third aspect may include any one of the thirty-seventh through forty-second aspects, wherein the separating station comprises: one or more preheating stations configured to heat a target region of the glass tube proximate the starting end of the glass tube; and a pulling station configured to convey the annular segment of the glass tube away from the glass tube in a direction parallel to the center axis of the glass tube.

A forty-fourth aspect may include the forty-third aspect, wherein each of the one or more preheating stations comprises a gas burner configured to heat the target region of the glass tube circumferentially as the glass tube rotates.

A forty-fifth aspect may include any one of the forty-third or forty-forth aspects, wherein the target region is less than or equal to 50 mm from the starting end of the glass tube.

A forty-sixth aspect may include any one of the forty-third through forty-fifth aspects, wherein the pulling station comprises: an end support roller configured to support the starting end of the glass tube; and a separation roller configured to exert an axial pulling force on the starting end of the glass tube, wherein the axial pulling force separates the annular segment from the glass tube.

A forty-seventh aspect may include the forty-sixth aspect, wherein the separation roller comprises a roller axis of rotation that makes an angle with the center axis of the glass tube that is between 10 degrees and 80 degrees.

A forty-eighth aspect may include any one of the thirty-seventh through forty-seventh aspects, wherein the polishing station comprises a gas burner configured to flame polish the meniscus of glass at the new end of the glass tube.

A forty-ninth aspect may include any one of the thirty-seventh through forty-eighth aspects, configured to finish the end of the glass tube such that the glass tube is substantially free of end cracks and inclusions.

A fiftieth aspect may include any one of the thirty-seventh through forty-ninth aspects, configured to finish the end of the glass tube such that the glass tube is substantially free of glass particulates fused to outer surfaces or inner surfaces of the glass tube.

A fifty-first aspect may include any one of the thirty-seventh through fiftieth aspects, further comprising a vent hole station configured to form a vent hole in the dome end glaze.

A fifty-second aspect may include the fifty-first aspect, wherein the vent hole station comprises a vent hole burner configured to melt and open the dome end glaze to form the vent hole.

A fifty-third aspect may include any one of the thirty-seventh through the fifty-second aspects, further comprising a forming station configured to modify the convex shape of the dome end glaze.

A fifty-fourth aspect may include the fifty-third aspect, wherein the forming station comprises a forming tool configured to reshape the meniscus.

A fifty-fifth aspect may include any one of the thirty-seventh through the fifty-fourth aspects, wherein: the separating station is configured to: remove a first annular segment of the glass tube from a first starting end of the glass tube, wherein removing the first annular segment from the first starting end of the glass tube forms a first meniscus of glass over a first new end of the glass tube; and remove a second annular segment of the glass tube from a second starting end of the glass tube, wherein removing the second annular segment from the second starting end of the glass tube forms a second meniscus of glass over a second new end of the glass tube; and the polishing station is configured to: polish the first meniscus of glass and the first new end of the glass tube to form a first dome end glaze at the first new end of the glass tube; and polish the second meniscus of glass and the second new end of the glass tube to form a second dome end glaze at the second new end of the glass tube, wherein the first dome end glaze comprises a first outer surface having a first convex shape and the second dome end glaze comprises an second outer surface having a second convex shape.

A fifty-sixth aspect may include any one of the thirty-seventh through the fifty-fifth aspects, wherein the conveyor is configured to receive the glass tube from a tube manufacturing process.

A fifty-seventh aspect may include any one of the thirty-seventh through the fifty-sixth aspects, wherein the longitudinal length L of the glass tube is greater than or equal to 800 mm.

Additional features and advantages of the systems and methods disclosed herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross-sectional view of a glass tube, according to one or more embodiments shown and described herein;

FIG. 2 schematically depicts a system for finishing one or both ends of glass tubes, according to one or more embodiments shown and described herein;

FIG. 3 schematically depicts a cross-sectional view of another embodiment of a glass tube, according to one or more embodiments shown and described herein;

FIG. 4 schematically depicts a cross-sectional view of another embodiment of a glass tube, according to one or more embodiments shown and described herein;

FIG. 5 schematically depicts a cross-sectional view of another embodiment of a glass tube, according to one or more embodiments shown and described herein;

FIG. 6A schematically depicts a top view of a glass tube having a vent hole, according to one or more embodiments shown and described herein;

FIG. 6B schematically depicts a cross-sectional side view of the glass tube of FIG. 6A, according to one or more embodiments shown and described herein;

FIG. 7 schematically depicts a cross-sectional view of another embodiment of a glass tube having a vent hole, according to one or more embodiments shown and described herein;

FIG. 8 schematically depicts a top view of a process for continuously producing glass tubes, according to one or more embodiments shown and described herein;

FIG. 9 schematically depicts a side elevation view of the process of FIG. 8 for continuously producing glass tubes, according to one or more embodiments shown and described herein;

FIG. 10 schematically depicts a conveyor of the system of FIG. 1, according to one or more embodiments shown and described herein;

FIG. 11 schematically depicts a preheating station of the system of FIG. 1, according to one or more embodiments shown and described herein;

FIG. 12A schematically depicts an embodiment of a pulling station of the system of FIG. 1, according to one or more embodiments shown and described herein;

FIG. 12B schematically depicts the pulling station of the system of FIG. 12A after an annular segment of a glass tube has been separated from the glass tube, according to one or more embodiments shown and described herein;

FIG. 13A schematically depicts an another embodiment of a pulling station of the system of FIG. 1, according to one or more embodiments shown and described herein;

FIG. 13B schematically depicts the pulling station of the system of FIG. 13A after an annular segment of a glass tube has been separated from the glass tube, according to one or more embodiments shown and described herein;

FIG. 14 schematically depicts a polishing station of the system of FIG. 1, according to one or more embodiments shown and described herein;

FIG. 15 schematically depicts a vent hole station of the system of FIG. 1, according to one or more embodiments shown and described herein; and

FIG. 16 schematically depicts a forming station of the system of FIG. 1, according to one or more embodiments shown and described herein.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

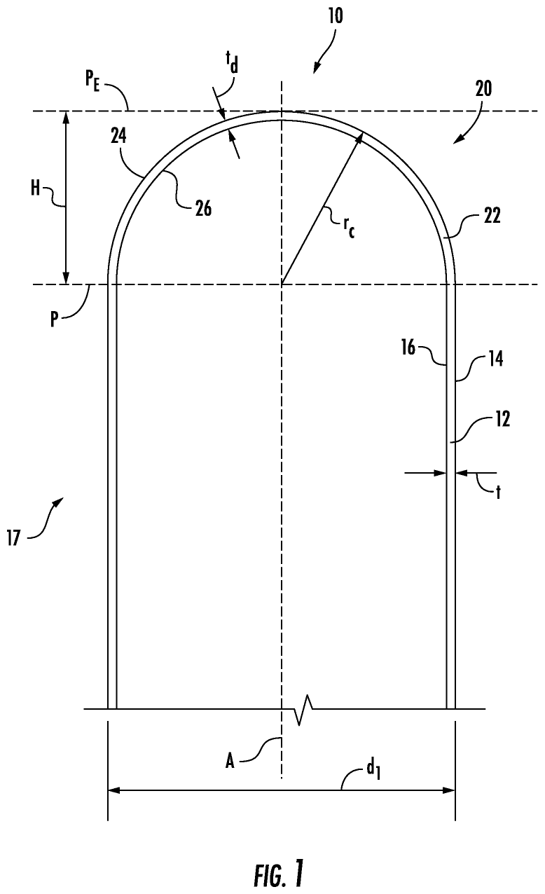

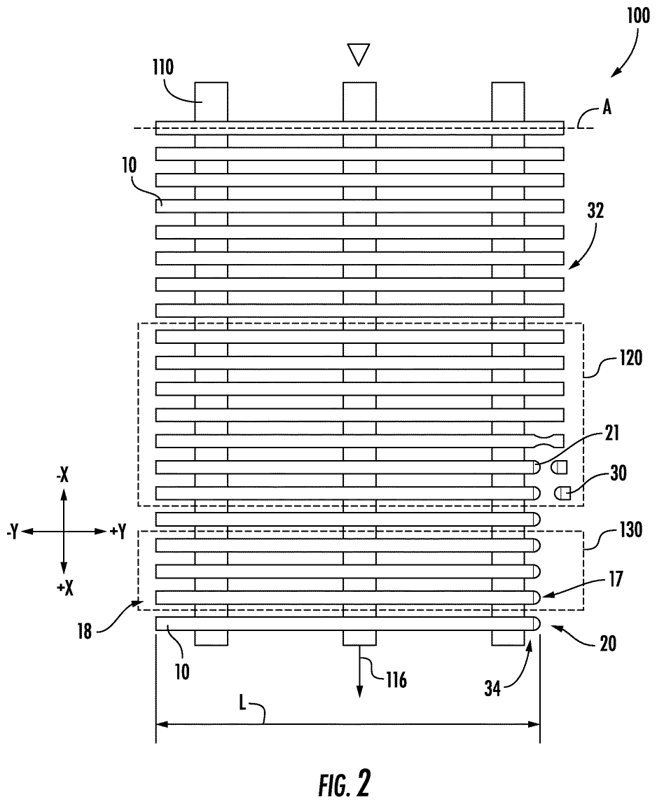

Reference will now be made in detail to embodiments of glass tubes having dome-shaped ends along with methods and systems for manufacturing the same. Whenever possible, the same reference numerals will be used throughout the drawings to refer to the same or like parts. Referring now to FIG. 1, a glass tube 10 (shown in cross section) of the present disclosure comprises a hollow cylindrical sidewall 12 comprising a glass and having an outer diameter d₁, an outer surface 14, an inner surface 16, a first end 17, a second end 18 (FIG. 2) opposite the first end 17, and a dome end glaze 20 comprising the glass and having an outer surface 24 with a convex shape. The dome end glaze 20 may be at the first end 17, the second end 18, or both. The glass tube 10 comprises a longitudinal length L (FIG. 2) greater than or equal to 30 times d₁.

Referring now to FIG. 2, systems 100 of the present disclosure for finishing one or both ends of glass tubes 10 may include a conveyor 110 operable to translate the glass tubes 10 horizontally while also rotating each of the glass tubes 10 about the center axis A of the respective glass tubes 10. The systems 100 further include a separating station 120 configured to remove an annular segment 30 of each glass tube 10 from a starting end 32 of the glass tube 10, wherein removing the annular segment 30 from the starting end 32 of the glass tube 10 forms a glass meniscus 21 over a new end 34 of the glass tube 10. The systems 100 may further include a polishing station 130 configured to shape the glass meniscus 21 at the new end 34 of the glass tube 10 to form the dome end glaze 20 at the new end 34 of the glass tube 10, wherein the dome end glaze 20 comprises the outer surface 24 having a convex shape. The longitudinal length L of the glass tube 10 may be greater than or equal to 30 times d₁. It should be noted that various gas burners and other processing equipment are not shown in the system 100 schematically depicted in FIG. 2. The conveyor 110 is schematically depicted with gas burners and other processing equipment in FIG. 10.

The systems 100 disclosed herein can be used in methods of finishing one or both ends of the glass tubes 10. The methods disclosed herein for finishing one or more ends of a glass tube 10 include rotating the glass tube 10 about the center axis A, removing the annular segment 30 of the glass tube 10 from the starting end 32 of the glass tube 10, wherein removing the annular segment 30 from the starting end 32 of the glass tube 10 forms the glass meniscus 21 over the new end 34 of the glass tube 10, and polishing the glass meniscus 21 at the new end 34 of the glass tube 10 to form the dome end glaze 20 at the new end 34 of the glass tube 10. Moreover, the methods disclosed herein for finishing one or both ends of glass tubes 10 may be used to produce glass tubes 10 comprising a longitudinal length L that may be greater than or equal to 30 times d₁.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

Directional terms as used herein—for example up, down, right, left, front, back, top, bottom—are made only with reference to the figures as drawn and are not intended to imply absolute orientation.

As used herein, the singular forms “a,” “an,” and “the” include plural referents unless the context clearly dictates otherwise. Thus, for example, reference to “a” component includes aspects having two or more such components, unless the context clearly indicates otherwise.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

As used herein, “axial” refers to a direction parallel to the center axis A of the glass tube.

As used herein, the terms “upstream” and “downstream” refer to the positions of features of the glass tube manufacturing process relative to a direction of travel of the glass tube through the manufacturing process. For instance, a first feature is “upstream” of a second feature if the glass tube encounters the first feature before encountering the second feature. Conversely, the first feature is “downstream” of the second feature if the glass tube encounters the second feature before encountering the first feature.

As used herein, the term “curvature” refers to the degree to which a curved surface deviates from a plane. It should be understood that “curvature” and “radius of curvature” are inversely related, meaning that as the radius of curvature decreases, the curvature of the surface increases.

Because of its hermeticity, optical clarity, and excellent chemical durability relative to other materials, glass has been a preferred material for pharmaceutical applications, including, without limitation, vials, syringes, ampoules, cartridges, jars, and other glass articles. These pharmaceutical glass containers, as well as other types of glass articles, can be produced through a process of converting a glass tube to one or more of the glass articles through a plurality of heating and forming operations.

In the glass packaging industry and particularly, in the glass pharmaceutical packaging industry, tubing damage arising during shipping and handling is a systemic source of inefficiency and quality control problems. Tubing damage arising during shipping and handling is very disruptive to those in the glass packaging industry that convert stock glass tubing into individual glass articles. When converting entities receive damaged glass tubes, the glass tubes are typically either scrapped or held in quarantine until an investigation can occur. In other cases, converting entities may either purposefully or inadvertently use the damaged tubing in one or more converting processes, which can lead to machine jams and significant downtime.

Conventional glass tubes used as starting material for converting operations suffer from poor mechanical properties associated with the finished ends of the glass tubes. In particular, the geometry of the finished ends of conventional glass tubes is not conducive to the avoidance of damage initiation during typical shipping and handling operations. In order to avoid the presence of sharp edges at the ends of glass tubes, existing finishing operations glaze the ends of the tubes leaving an open end with a glass bead (glaze) around the rim of the glass tube. In some instances, the ends of the glass tubes are finished by sealing off the ends of the tubes so as to form a flat bottom in an end glazing process generally referred to as “bottoming.” However, the finished ends resulting from both of these end glazing techniques possess physical features having small radii that can act as stress risers at the ends of the glass tubes. As such, when existing tubes experience contact with each other and with other packaging equipment, e.g., pallets, these physical features experience elevated stress levels that often result in damage, e.g., cracks, at the ends of the glass tubes. Accordingly, a need exists in the glass packaging industry for glass tubes having improved end geometries that are capable of withstanding contacts that are typically experienced by glass tubes during shipping and handling.

Additionally, processing operations associated with conventionally finished ends often introduce defects into the glass tubes which can be problematic for the glass tubes themselves and the converted glass articles produced therefrom. Accordingly, there is a demand for glass tubes having reduced defects associated with processing operations involved in finishing the ends of the glass tubes, as well as methods and systems capable of finishing the ends of glass tubes so as to efficiently produce glass tubes having these attributes.

The present disclosure addresses these needs by introducing a new type of finished end for glass tubes along with methods and systems for manufacturing the new finished end. In particular, the present disclosure is directed to glass tubes having dome-shaped ends that result in improved mechanical properties and reduced breakage of the glass tubes during shipping and handling. Further, glass tubes having the dome-shaped ends of the present disclosure are higher in quality than glass tubes having conventionally finished ends due to the methods and systems used to finish glass tubes having dome-shaped ends.

The glass tubes of the present disclosure have a dome end glaze at one or both ends of the glass tubes. The dome end glaze has an outer surface with a convex shape having a larger minimum radius than that possessed by physical features of glass tubes with conventional end glazing, such as the glass bead or flat bottom. The dome end glaze disclosed herein is generally a hemisphere of glass that closes off the end of the glass tube to provide a rounded geometry. The rounded geometry of the dome end glaze reduces stress risers (small radii or corners) compared to open ends and/or flat bottom ends, and creates a deflecting contact surface. Thus, when the glass tubes with the dome end glaze, as disclosed herein, experience typical contact forces associated with shipping and handling, the dome end glaze is able to redistribute the force over a larger area thereby reducing the likelihood of damage in the form of chipping, cracking, or breakage. Moreover, the distribution of contact forces over a larger region of the end of the glass tube may enable the impact energy to be used in the repositioning of the tube end of the glass tube instead of creating localized fractures in the glass at the tube end. Further, as discussed in more detail below, the systems and methods disclosed herein for making glass tubes having the dome-shaped ends may result in the higher quality tube ends (less defects) and a simplified process operation which improves manufacturing efficiency, among other features.

Referring again to FIG. 1, the glass tubes 10 of the present disclosure are now described in more detail. As previously discussed, the glass tube 10 comprises a hollow cylindrical sidewall 12 and a dome end glaze 20 at one or more of the ends of the glass tube 10. The dome end glaze 20 may be at the first end 17, the second end 18, or both. The transition between the hollow cylindrical sidewall 12 and the dome end glaze 20 may be defined by a plane P at the ends of the hollow cylindrical sidewall 12. Plane P is normal to a center axis A of the glass tube 10. Each of the first end 17 and second end 18 comprises an end plane P_{E} defined as a plane normal to the center axis A and at the extremity of the respective tube end in the direction of the center axis A (FIGS. 3-5 and 6B). The dome end glaze 20 may comprise a dome height H defined as the distance between plane P and end plane P_{E} along the center axis A. The glass tube 10 further comprises a longitudinal length L (FIG. 2) defined as the distance from the end plane P_{E} at the first end 17 to the end plane P_{E} at the second end 18 along the center axis A. The longitudinal length L refers to the finished length of the glass tube 10.

The longitudinal length L of the glass tube 10 may be greater than or equal to a multiple of the outer diameter d₁ of the glass tube 10 so as to define an aspect ratio of the glass tube 10. For example, in embodiments, the longitudinal length L of the glass tube 10 may be greater than or equal to 10 times d₁, greater than or equal to 15 times d₁, greater than or equal to 20 times d₁, greater than or equal to 25 times d₁, greater than or equal to 30 times d₁, greater than or equal to 35 times d₁, greater than or equal to 40 times d₁, greater than or equal to 45 times d₁, or greater than or equal to 50 times d₁. In embodiments, the longitudinal length L of the glass tube 10 may be greater than or equal to 200 mm, greater than or equal to 210 mm, greater than or equal to 220 mm, greater than or equal to 230 mm, greater than or equal to 240 mm, greater than or equal to 250 mm, greater than or equal to 260 mm, greater than or equal to 270 mm, greater than or equal to 280 mm, greater than or equal to 290 mm, or greater than or equal to 300 mm. In embodiments, the longitudinal length L of the glass tube 10 may be greater than or equal to 244 mm. In embodiments, the longitudinal length L of the glass tube 10 may be greater than or equal to 310 mm. In embodiments, the longitudinal length L of the glass tube 10 may be greater than or equal to 400 mm, greater than or equal to 500 mm, greater than or equal to 600 mm, greater than or equal to 700 mm, greater than or equal to 750 mm, greater than or equal to 800 mm, greater than or equal to 850 mm, greater than or equal to 900 mm, greater than or equal to 1000 mm, greater than or equal to 1100 mm, greater than or equal to 1200 mm, greater than or equal to 1300 mm, greater than or equal to 1400 mm, or greater than or equal to 1500 mm. In embodiments, the longitudinal length L of the glass tube 10 may be greater than or equal to 1502 mm. In embodiments, the longitudinal length L of the glass tube 10 may be less than or equal to 1600 mm.

In embodiments, the outer diameter d₁ of the hollow cylindrical sidewall 12 of the glass tube 10 may be about 8.15 mm, 16.00 mm, 24.00 mm, 30.00 mm, or 47.00 mm. In embodiments, the outer diameter d₁ of the hollow cylindrical sidewall 12 of the glass tube 10 may be from 4.00 mm to 325.00 mm, from 4.00 mm to 300.00 mm, from 4.00 mm to 250.00 mm, from 4.00 mm to 200.00 mm, from 4.00 mm to 150.00 mm, from 4.00 mm to 100.00 mm, from 4.00 mm to 90.00 mm, from 4.00 mm to 80.00 mm, from 4.00 mm to 70.00 mm, from 5.00 mm to 60.00 mm, from 5.00 mm to 50.00 mm, from 6.00 mm to 50.00 mm, from 10.00 mm to 50.00 mm, from 10.00 mm to 40.00 mm, from 15.00 mm to 40.00 mm, or from 20.00 mm to 40.00 mm.

In embodiments, the outer diameter d₁ of the hollow cylindrical sidewall 12 of the glass tube 10 may correspond to standardized outer diameters for glass pharmaceutical vials, such as those provided in ISO 8362-1:2018 or in standards created by the Glass Packaging Institute (GPI). In embodiments, the outer diameter d₁ of the hollow cylindrical sidewall 12 of the glass tube 10 may correspond to standardized outer diameters for glass ampoules, such as those provided in ISO 9187-1: 2010. In embodiments, the outer diameter d₁ of the hollow cylindrical sidewall 12 of the glass tube 10 may correspond to standardized outer diameters for glass syringes, such as those provided in ISO 11040-4. In embodiments, the outer diameter d₁ of the hollow cylindrical sidewall 12 of the glass tube 10 may correspond to standardized outer diameters for glass cartridges, such as those provided in ISO 21881:2019.

The dome end glaze 20 may be formed by a dome wall 22 having wall thickness td defined by the distance between an outer surface 24 of the dome wall 22 and an inner surface 26 of the dome wall 22. In embodiments, the wall thickness t_{d} of the dome end glaze 20 may be less than or equal to a wall thickness t of the hollow cylindrical sidewall 12, defined as the distance between the outer surface 14 the inner surface 16. In embodiments, the wall thickness t_{d} of the dome end glaze 20 may be greater than or equal to the wall thickness t of the hollow cylindrical sidewall 12. In embodiments, the wall thickness t_{d} of the dome end glaze 20 is uniform over the dome end glaze 20. In other embodiments, the wall thickness t_{d} of the dome wall 22 forming the dome end glaze 20 may vary based on position on the dome end glaze 20. For example, in embodiments, the wall thickness t_{d} of the dome wall 22 may be thicker near the hollow cylindrical sidewall 12 compared to the wall thickness t_{d} in a central region of the dome end glaze 20 proximate the center axis A.

The convex shape of the outer surface 24 of the dome end glaze 20 may have a radius of curvature r_{c}. In embodiments, the radius of curvature r_{c} of the convex shape of the outer surface 24 is greater than or equal to 0.3 times d₁, greater than or equal to 0.4 times d₁, or greater than or equal to 0.45 times d₁ over positions on the convex shape that are within a distance of 0.4 times d₁ from the center axis A of the glass tube 10. In embodiments, the radius of curvature r_{c} of the convex shape of the outer surface 24 is less than or equal to 0.7 times d₁, less than or equal to 0.6 times d₁, or less than or equal to 0.55 times d₁ over positions on the convex shape that are within a distance of 0.4 times d₁ from the center axis A of the glass tube 10.

In embodiments, the radius of curvature r_{c} of the convex shape of the outer surface 24 is between 0.3 times d₁ and 0.7 times d₁ over positions on the convex shape that are within a distance of 0.4 times d₁ from the center axis A of the glass tube 10. In embodiments, the radius of curvature r_{c} of the convex shape of the outer surface 24 is between 0.3 times d₁ and 0.5 times d₁ over positions on the convex shape that are within a distance of 0.4 times d₁ from the center axis A of the glass tube 10. In embodiments, the radius of curvature r_{c} of the convex shape of the outer surface 24 is between 0.5 times d₁ and 0.7 times d₁ over the entire convex shape. In embodiments, the radius of curvature r_{c} of the convex shape of the outer surface 24 is between 0.5 times d₁ and 0.7 times d₁ over positions on the convex shape that are within a distance of 0.4 times d₁ from the center axis A of the glass tube 10. In embodiments, the radius of curvature r_{c} of the convex shape of the outer surface 24 is greater than or equal to 0.4 times d₁ and less than or equal to 0.6 times d₁ over positions on the convex shape that are within a distance of 0.4 times d₁ from the center axis A of the glass tube 10. In embodiments, the radius of curvature r_{c} of the convex shape of the outer surface 24 is greater than or equal to 0.45 times d₁ and less than or equal to 0.55 times d₁ over positions on the convex shape that are within a distance of 0.4 times d₁ from the center axis A of the glass tube 10.

In the embodiment of the glass tube 10 shown in FIG. 3, the radius of curvature r_{c} of the convex shape of the outer surface 24 is about 0.5 times d₁ over positions on the convex shape that are within a distance of 0.4 times d₁ from the center axis A of the glass tube 10. The portion of the convex shape of the outer surface 24 corresponding to positions on the convex shape that are within a distance of 0.4 times d₁ is illustrated in FIG. 3 as hatched portion H. In embodiments where r_{c} is about 0.5 times d₁, the dome end glaze 20 approximates a glass hemisphere at the end of the glass tube 10. Without wishing to be bound by theory, it is believed that embodiments wherein the radius of curvature r_{c} of the convex shape is about 0.5 times d₁ offer particularly good mechanical properties as a result of the maximum curvature of the outer surface 24 of the end of the glass tube 10 corresponding with the theoretical limit based on outer diameter d₁ of the glass tube 10. As discussed above, features with increased curvature (e.g., smaller radius of curvature) at the ends of glass tubes may experience greater localized stress as a result of a limited ability to distribute contact forces over a broader area. The dome-shaped ends of the glass tubes 10 of the present disclosure may reduce the maximum curvature of the finished ends of the glass tubes relative to currently available glass tubes. In embodiments, the radius of curvature r_{c} of the convex shape of the outer surface 24 is about 0.5 times d₁ over the entire convex shape.

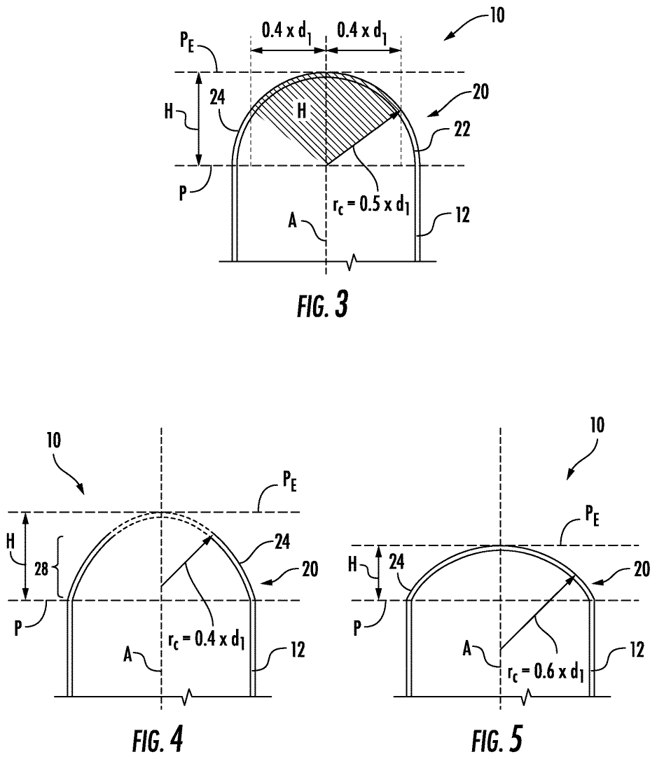

In the embodiment of the glass tube 10 shown in FIG. 4, the radius of curvature r_{c} of the convex shape of the outer surface 24 is greater than or equal to 0.4 times d₁ over positions on the convex shape that are within a distance of 0.4 times d₁ from the center axis A of the glass tube 10. As can be observed from FIG. 4, in embodiments wherein the convex shape has a radius of curvature r_{c} less than 0.5 times d₁ over positions on the convex shape that are within a distance of 0.4 times d₁ from the center axis A of the glass tube 10, the radius of curvature r_{c} may vary depending on the position on the outer surface 24 in which the radius of curvature r_{c} is measured. The dome end glaze in such embodiments may include a tapered region 28 where which the radius of curvature r_{c} varies from a relatively large value near the hollow cylindrical sidewall 12 to a relatively smaller value near the center axis A. When the radius of curvature r_{c} of the convex shape is less than 0.3 times d₁, the dome end glaze 20 may be limited in its ability to distribute contact forces over a broader area.

In the embodiment of the glass tube 10 shown in FIG. 5, the radius of curvature r_{c} of the convex shape of the outer surface 24 is greater than or equal to 0.5 times d₁ and less than or equal to 0.7 times d₁ over positions on the convex shape that are within a distance of 0.4 times d₁ from the center axis A of the glass tube 10. When the radius of curvature r_{c} of the convex shape is greater than 0.7 times d₁, the transition between the hollow cylindrical sidewall 12 and the dome end glaze 20, i.e., at plane P, may be associated with high curvature thereby providing a potential stress riser that may lead to an increased risk of breakage from contact.

As discussed above, the dome end glaze 20 of the glass tube 10 may comprise a dome height H defined as the distance between plane P and end plane P_{E} along the center axis A. In embodiments the dome height H may be greater than or equal to 0.3 times d₁, greater than or equal to 0.4 times d₁, or greater than or equal to 0.45 times d₁. In embodiments the dome height H may be less than or equal to 0.7 times d₁, less than or equal to 0.6 times d₁, or less than or equal to 0.55 times d₁. In embodiments, the dome height H may be between 0.3 times d₁ and 0.7 times d₁, between 0.3 times d₁ and 0.5 times d₁, between 0.5 times d₁ and 0.7 times d₁, between 0.4 times d₁ and 0.6 times d₁, or between 0.45 times d₁ and 0.55 times d₁. In embodiments, the dome height H may be about 0.5 times d₁.

In embodiments, the glass tubes 10 may comprise a first dome end glaze at the first end 17 of the glass tube 10 and a second dome end glaze at the second end 18 of the glass tube 10. In embodiments, the dome end glaze 20 closes off the glass tube 10 at the first end 17 of the glass tube 10, the second end 18 of the glass tube 10, or both. Embodiments wherein both ends of the glass tube 10 are closed off by dome end glaze 20 features may be particularly suitable for pharmaceutical packaging applications as closing off both ends may prevent contaminants from entering the inside of the glass tube 10.

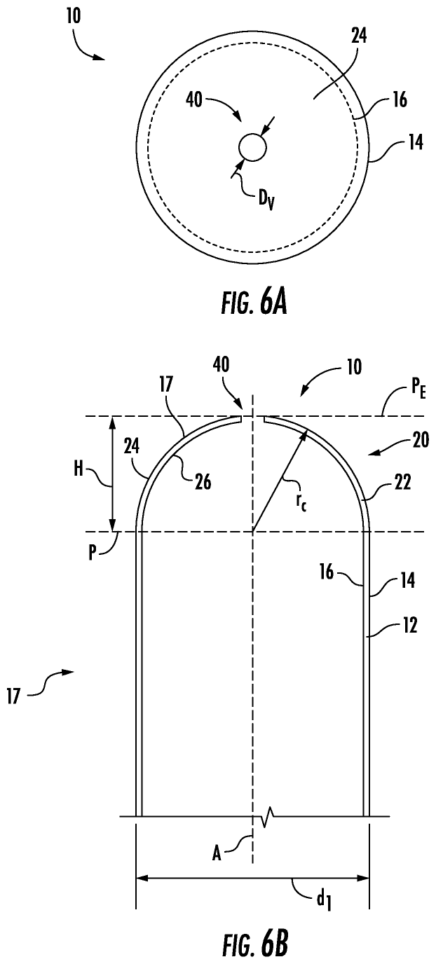

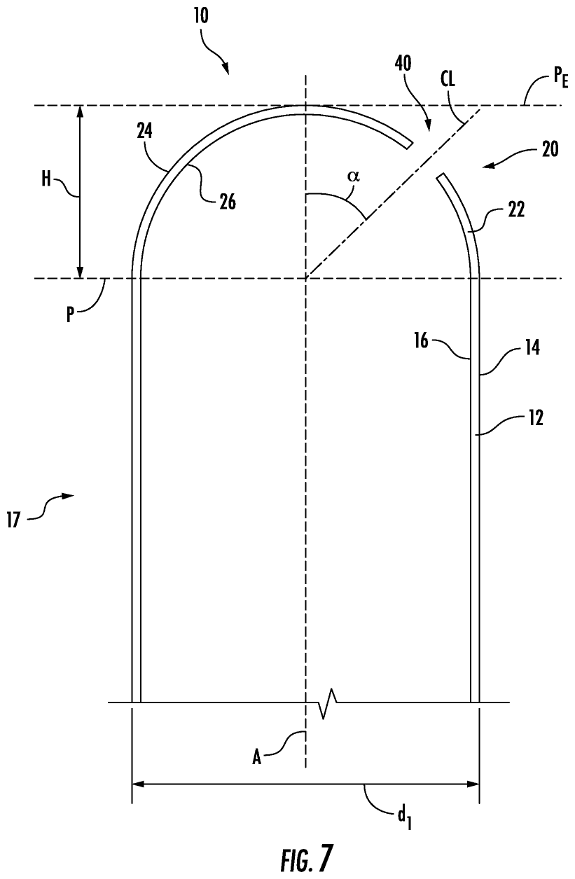

Referring now to FIGS. 6A and 6B, in embodiments, the glass tubes 10 of the present disclosure may further include a vent hole 40 in the dome end glaze 20. In some instances, conventional glass tube finishing may involve the placement of vent holes in the near the ends of the glass tubes for the purpose of reducing the pressure on the inside of the glass tube during certain converting operations. Typically, in conventional glass tube finishing processes, the vent hole is introduced through the cylindrical sidewall of the glass tube so that the vent hole is oriented perpendicular to the center axis A of the glass tube, which, in combination with the tight radius associated with the transition of the cylindrical sidewall to the flat bottom, creates a stress riser at the ends of the glass tube. Stress risers associated with this transition and the sidewall vent hole may increase the likelihood that the end of the tube is damaged during typically shipping and handling operations.

Referring again to FIGS. 6A and 6B, the glass tubes 10 disclosed herein may have the vent hole 40 disposed in the dome end glaze 20 rather than in the sidewall 12 of the glass tube 10. It has been found that the glass tubes 10 comprising the dome end glaze 20 with the vent hole 40 disposed therein may exhibit improved mechanical properties relative to conventional glass tubes despite the presence of the vent hole. Without wishing to be bound by theory, it is believed the location of the vent hole 40 being isolated from a region of sharp curvature of the end glazing (e.g., the transition from the sidewall to the bottom in conventional flat bottom glass tubes) may reduce the potentially harmful impact that the presence of the vent hole 40 has on the finished end of the glass tube 10. With reference again to FIG. 6B, a cross-section of glass tube 10 comprising a vent hole 40 through the dome end glaze 20 is depicted. FIG. 6A depicts an end view of the glass tube 10 comprising a vent hole 40 through the dome end glaze 20. In embodiments, the dome end glaze 20 may covers at least 65%, at least 70%, at least 70%, at least 75%, at least 80%, or at least 85% of a cross-sectional area of the glass tube 10 at the first end 17, the second end 18, or both.

In embodiments, the vent hole 40 may have a diameter Dᵥ of between 0.01 times d₁ and 0.25 times d₁, between 0.05 times d₁ and 0.20 times d₁, or between 0.10 times d₁ and 0.20 times d₁. In embodiments, the vent hole 40 may have a diameter Dᵥ of between 1 mm and 5 mm or between 2 mm and 4 mm. In embodiments, the vent hole 40 may have a diameter Dᵥ of 3 mm.

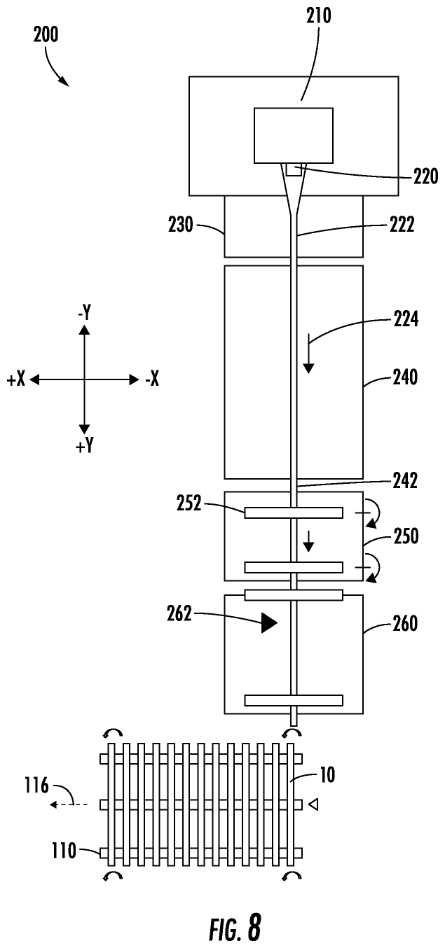

In the embodiment shown in FIGS. 6A and 6B, the vent hole 40 may be aligned with the center axis A of the glass tube 10. In embodiments, the vent hole 40 may be offset from the center axis A of the glass tube 10. Referring now to FIG. 7, in embodiments, the vent hole 40 may be offset from the center axis A of the glass tube 10 so that a center line CL of the vent hole 40 makes an angle α with a center axis A of the glass tube 10 that is less than 80 degrees, less than 70 degrees, or less than 45 degrees. In embodiments, the center line CL of the vent hole 40 makes an angle α with the center axis A of the glass tube 10 that is about 45 degrees. In embodiments, the center line CL of the vent hole 40 is not perpendicular with the center axis A of the glass tube 10.

In embodiments of the glass tube 10 including the vent hole 40, the radius of curvature r_{c} of the convex shape of the outer surface 24 does not include areas of the dome end glaze 20 that have been reshaped as a result of the presence of the vent hole 40. That is to say, in determining whether a glass tube 10 comprises a specified radius of curvature r_{c} over positions on the convex shape that are within a distance of 0.4 times d₁ from the center axis A of the glass tube 10, the high curvature (low radius of curvature) associated with the wall of the dome end glaze 20 surrounding the vent hole 40 should not be considered.

In embodiments, the glass tubes 10 may be substantially free of surface defects, such as but not limited to cracks, scratches, or any other surface inclusions. In embodiments, the glass tubes 10 may have an Acceptable Quality Level of less than 0.25 for end cracks having a crack length of greater than 2 mm. Acceptable Quality Level (AQL) is defined according to ISO 2859-1. End cracks refer to cracks appearing in the axial ends of the glass tubes 10. In embodiments, the glass tubes 10 may have an AQL of less than or equal to 0.025 for surface cracks of any size and any length. Surface cracks refer to cracks in the outer surface and/or inner surface of the glass tubes 10 (i.e., not the end surfaces).

In embodiments, the glass tubes 10 may be substantially free of glass particulates fused to outer surfaces 14 and inner surfaces 16 of the hollow cylindrical sidewall 12. In embodiments, the glass tubes 10 may have zero glass particles having a diameter of greater than 0.5 mm attached to the outer surfaces 14 or inner surfaces 16 of the glass tubes 10. In embodiments, the glass tubes 10 may have less than or equal to 5 glass particles having diameters from 0.2 mm to less than 0.5 mm attached to the outer surfaces 14 or inner surfaces 16 of the glass tubes 10. In embodiments, the glass tubes 10 may have an AQL of less than 0.1 for impurities measuring greater than 1 mm that are on the outer surfaces 14 of the glass tubes 10 and are not easily removed. In embodiments, the glass tubes 10 may have an AQL of less than 0.1 for impurities measuring greater than 0.5 mm that are on the inner surfaces 16 of the glass tubes 10 and are not easily removed.

In conventional tube manufacturing processes, the glass tubes are cut to final length using a combination of mechanical tools for crack (scratch) initiation, heating by gas burners, and quenching the glass tubes in order to create a thermal shock condition and to propagate the crack around the circumference of the glass tube to complete separation of a section from the end of the glass tube. After the cut is made at both ends, the edges at the ends of the glass tube are finished through fire polishing (i.e., end glazing) using the gas burners. The conventional manufacturing processes for final cut-to-length and edge finishing are well established but present a number of challenges and opportunities for improvement, especially considering the present increasing demand for pharmaceutical products and increasing focus on high quality and manufacturing efficiency.

Demand is increasing for end finishing steps in tube manufacturing processes that enable high quality of the tube ends (no glass defects, acceptable geometry, high strength) and accurate final length of the tube while achieving low loss and high yield at high processing speeds. As mentioned above, the existing processes for performing the final cut-to-length rely on creation of an initial scratch on the surface of the tube performed by a cutting blade (or other mechanical tools) and on the subsequent propagation of the crack. The creation of a fracture surface, which is started from the initial mechanical defect and propagated around the circumference of the glass tube by a thermal stress, is not very accurate and requires several processing steps, which is not efficient. Additionally, separation is typically followed by edge fire polishing, which is needed to remediate surface flaws created by the score and break method. Edge or end fire polishing represents an additional process step and takes extra time to be completed, further reducing the efficiency of the manufacturing process.

Products in pharmaceutical packaging such as vials, cartridges, syringes, ampoules, or other containers, which are converted from glass tubing, require a high level of cleanliness. Mechanical initiation of the crack, which is used in the current conventional end finishing processes, scratches the surface of the tube, which generates glass particles that contaminate the outer surfaces and inner surfaces of the glass tubes. These glass particles then have to be removed from the glass tubes through a thorough cleaning process. The cleaning process becomes more complicated if a large number of particles is generated during the manufacturing process, and especially, when glass particles adhere to the surface, such as by fusing to the glass surface during fire polishing of the edges of the glass tubes.

Further, as discussed above, certain glass tube products require sealed tube ends. In conventional glass tube manufacturing processes, sealing the ends of the glass tubes is currently performed at the end of the conveyor line described above as an additional step done using gas burners after the final cut to length and edge polishing. The use of gas burners to seal the ends of the glass tubes adds an additional manufacturing step, which reduces the efficiency of the manufacturing process. Therefore, there is a need for more efficient end finishing processes to that improve the quality of the glass tubes produced therefrom.

In addition to the glass tubes having dome-shaped ends discussed above, the present application is also directed to systems and methods for the separation and finishing of the ends of the glass tubes during, or alternatively, independently from, tube production processes (i.e., from a glass melt). The systems and methods disclosed herein demonstrate improved manufacturing efficiency by combining the final cut-to-length and edge polishing steps associated with conventional tube manufacturing processes. Moreover, the systems and methods disclosed herein do not require the sequence of steps associated with the conventional final cut-to-length process involving mechanical tools for crack (scratch) initiation, heating by gas burners, and quenching of the glass tubes, as discussed above. By omitting the additional scratch-heat-quench sequence of conventional final cut-to-length operations, the associated generation of glass particles and potential fusing of the glass particles during fire polishing of the ends of the glass tubes can be avoided. The avoidance of glass particle generation and potential fusing of the glass particles to the glass tubes reduces the need for cleaning processes designed to remove said particles. Moreover, as explained in more detail below, the systems and methods disclosed herein for finishing the ends of glass tubes with the creation of dome-shaped ends may result in the glass tubes being substantially free of end cracks and inclusions, which reduces the edge polishing requirements needed after conventional final cut-to-length processes.

Further, glass tubes manufactured so as to be substantially free of both fused glass particulates and end cracks and inclusions are of higher quality and, when used as stock glass tubing for converting operations, may lead to improved quality of the glass articles produced therefrom and greater yield. Additionally, the systems and methods disclosed herein produce glass tubes with improved mechanical properties such as higher durability of the glass tubes during typical shipping and handling operations. Moreover, for glass tubes requiring sealed ends, the systems and methods of the present disclosure avoid the need for the additional bottoming step at the end of the conveyor. The systems and methods disclosed herein form a sealed end during the separation step and thus are believed to be particularly efficient for the production of glass tubes requiring sealed ends, among other features.

The systems and methods of the present disclosure are now discussed in more detail. The systems and methods disclosed herein may be utilized independently or as part of the production process for manufacturing glass tubes. In the production process for manufacturing glass tubes, molten glass is first formed into a continuous hollow glass cylinder using a glass tube forming process. Processes for forming molten glass into a continuous hollow glass cylinder can include the Danner process, the Vello process, or other current or future developed processes for producing continuous hollow glass cylinders. The continuous hollow glass cylinder is then pulled through an annealing process and then cut into individual glass tubes having an initial length.

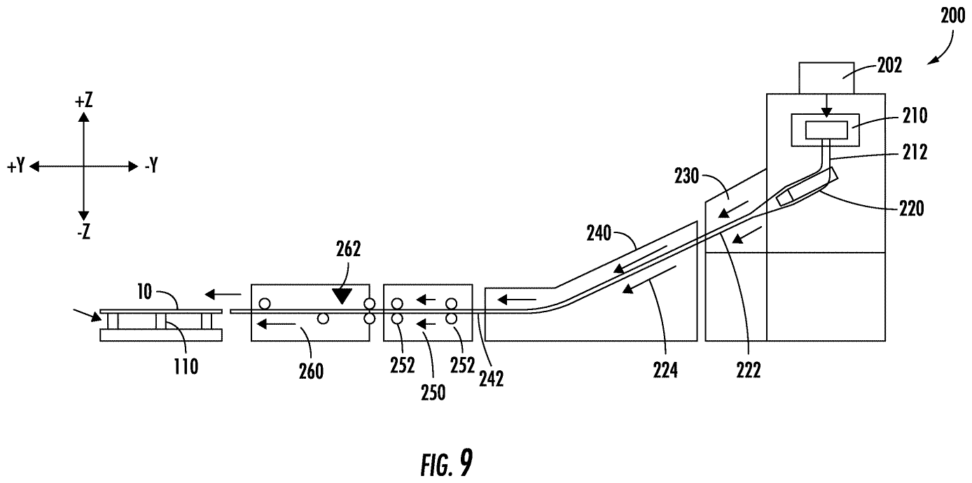

Referring now to FIGS. 8 and 9, one embodiment of a system 200 for producing a plurality of glass tubes 10 is schematically depicted. The system 200 may include a melt furnace 210, a glass tube forming apparatus 220 downstream of the melt furnace 210, a muffle furnace 230 downstream of the glass tube forming apparatus 220, an annealing section 240 downstream of the muffle furnace 230, a tube puller 250 downstream of the annealing section 240, a continuous tube cutter 260 downstream of the tube puller 250, and the conveyor 110 disposed downstream of the continuous tube cutter 260.

In operation of the system 200, a glass 202 is introduced to the melt furnace 210, which is operable to melt the glass to form a molten glass 212. The molten glass 212 is then passed to the glass tube forming apparatus 220, which is operable to form the molten glass 212 into a continuous hollow glass cylinder 222. As shown in FIG. 9, in embodiments, the glass tube forming apparatus 220 may be a tube forming apparatus used in the Danner process, in which the molten glass 212 runs from a feeder to a rotatable inclined hollow cylinder and is drawn off of the rotatable inclined hollow cylinder into the muffle furnace 230 by the tube puller 250 to produce the continuous hollow glass cylinder 222. While drawing the continuous hollow glass cylinder 222 off of the glass tube forming apparatus 220, compressed air or other gas supplied to the center of the continuous hollow glass cylinder 222 through the glass tube forming apparatus 220 along with the vacuum applied from the outside of the continuous hollow glass cylinder 222 help to control tube diameter and prevent the continuous hollow glass cylinder 222 from collapsing before cooling enough to retain its shape. Although shown as a Danner process in FIG. 9, it is understood that the continuous hollow glass cylinder 222 may be made using the Vello process or any other current or future process for making continuous hollow glass cylinders.

Referring again to FIGS. 8 and 9, after being formed, the continuous hollow glass cylinder 222 is then pulled through the muffle furnace 230 and the annealing section 240 by the tube puller 250. The annealing section 240 may be operable to anneal the continuous hollow glass cylinder 222 to produce an annealed continuous hollow glass cylinder 242. The tube puller 250 may include one or more sets of driven rollers 252 operable to exert a pulling force on the annealed continuous hollow glass cylinder 242 sufficient to pull it through the muffle furnace 230 and the annealing section 240. After passing the annealing section 240 and the tube puller 250, the annealed continuous hollow glass cylinder 242 passes to a tube cutter 260, where the annealed continuous hollow glass cylinder 242 is rough cut into glass tubes 10 having an initial length.

Since the first cut performed by the tube cutter 260 is a rough cut, further processing of the glass tubes 10 is conducted to cut the glass tubes 10 to a final length and finish the ends of the glass tubes 10. Referring to FIG. 8, after the tube cutter 260, the glass tubes 10 are conveyed in a direction 116 perpendicular to the draw direction 224 for end finishing and the creation of dome-shaped ends.

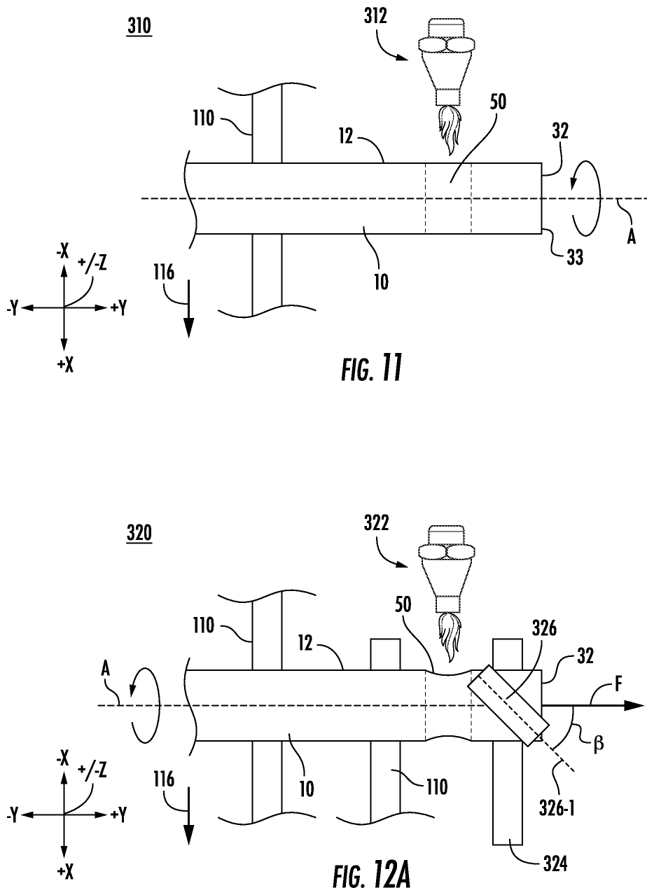

Referring again to FIG. 10, the systems 100 of the present disclosure for finishing one or both ends of glass tubes 10 may include a conveyor 110 operable to translate the glass tubes 10 horizontally while also rotating each of the glass tubes 10 about the center axis A of the respective glass tubes 10. The systems 100 further include a separating station 120 configured to remove an annular segment 30 of each glass tube 10 from a starting end 32 of the glass tube 10, wherein removing the annular segment 30 (FIG. 12B) from the starting end 32 of the glass tube 10 forms a glass meniscus 21 over a new end 34 of the glass tube 10. Once the annular segment 30 of each glass tube 10 is removed, the glass tube 10 comprises a longitudinal length L as described above, i.e., the longitudinal length L of the glass tube may be greater than or equal to a multiple of the outer diameter d₁ of the glass tube 10 so as to define an aspect ratio of the glass tube 10. In embodiments, the longitudinal length L of the glass tube 10 may be greater than or equal to 30 times d₁. In embodiments, the system 100 is configured to finish the ends of glass tubes 10 wherein the finished glass tubes 10 have a longitudinal length L greater than or equal to 800 mm. In embodiments, the systems 100 may further include a polishing station 130 configured to shape the glass meniscus 21 at the new end 34 of the glass tube 10 to form the dome end glaze 20 at the new end 34 of the glass tube 10, wherein the dome end glaze 20 comprises the outer surface 24 having a convex shape. In embodiments, the system 100, e.g., the conveyor 110, may be configured to receive the glass tube 10 from a tube manufacturing process such as system 200 discussed above.

It should be understood that while various operations of the systems 100 are described with reference to “a glass tube 10” or “the glass tube 10,” the systems and methods herein disclosed are applicable to the manufacturing of a plurality of glass tubes 10. Each of the glass tubes 10 may be passed in succession through each of the processing stations, such as but not limited to one or more preheating stations, a separating station, a polishing station, a vent hole station, a forming station, or combinations of these.

Referring again to FIG. 10, in embodiments, the conveyor 110 may comprise a plurality of conveying rollers 112 and a plurality of belts 114. The conveyor 110 may be operable to translate a plurality of glass tubes 10 horizontally in the machine direction 116 (i.e, in the +X direction of the coordinate axis in FIG. 10 (perpendicular to the center axis A of the glass tubes 10)) while also rotating each of the glass tubes 10 about the center axis A of the glass tubes 10. The plurality of conveying rollers 112 may be arranged side-by-side in the +/−X direction of the coordinate axis in FIG. 10. In embodiments, the respective axes of rotation of the conveying rollers 112 and may extend axially in the +/−Y direction, which may be parallel to the center axis A of the glass tubes 10. The conveying rollers 112 may be rotatable in the same rotational direction. The conveyor 110 may include multiple sets of conveying rollers 112, each conveying roller 112 of a set being arranged side-by-side in the +/−X direction of the conveyor 110 but being spaced from conveying rollers 112 of other sets in the +/−Y direction to support the glass tubes 10 at various positions along the length of the glass tubes 10.

Each of the glass tubes 10 may be positioned in a converging gap between two adjacent conveying rollers 112 and supported through contact with the adjacent conveying rollers 112. In embodiments, each of the glass tubes 10 are positioned in the converging gap between two adjacent conveying rollers 112 after having been cut to an initial length by the tube cutter 160 (FIG. 8). Contact of the outer surface 14 of the glass tubes 10 with the surfaces of the conveying rollers 112, while the conveying rollers 112 are rotated, may rotate the glass tubes 10 about the center axis A of the glass tubes 10.

The plurality of belts 114 may be operatively coupled to a drive motor (not shown), which may cause the belts 114 to move along a belt path. The belts 114 may contact a portion of the conveying rollers 112 such that, as the belts 114 are moved along the belt path, contact between the belts 114 and the conveying rollers 112 may translate the conveying rollers 112 and the glass tubes 10 disposed between each of the conveying rollers 112 horizontally (i.e., in the +X direction of the coordinate axis of FIG. 10). Contact of one or more of the belts 114 with the conveying rollers 112 may further cause rotation of the conveying rollers 112 to facilitate rotation of the glass tubes 10. In embodiments, the drive motor operatively coupled to the belts 114 may be a variable speed drive which may be operable to change a speed of the conveyor 110 for translating the plurality of glass tubes 10. Although described as having a plurality of conveying rollers 112 and belts 114, it is understood that the conveyor 110 can have other configurations, as long as the conveyor is operable to translate the glass tubes 10 horizontally while at the same time rotating the glass tubes 10 about the center axis A of each glass tube. As shown in FIG. 10, the conveyor 110 may be operable to translate the glass tubes 10 through the separating station 120 and the polishing station 130.

As mentioned above, the system 100 may comprise a separating station 120 configured to remove an annular segment 30 of the glass tube 10 from a starting end 32 of the glass tube 10. As previously discussed, removing the annular segment 30 from the starting end 32 of the glass tube 10 forms a glass meniscus 21 over a new end 34 of the glass tube 10. In embodiments, the separating station 120 includes one or more preheating stations 310 and a pulling station 320. The one or more preheating stations 310 may be configured to heat a target region 50 of the glass tube 10 proximate the starting end 32 of the glass tube 10. The pulling station 320 may be operable to convey the annular segment 30 of the glass tube 10 away from the glass tube 10 in a direction parallel to the center axis A of the glass tube 10.

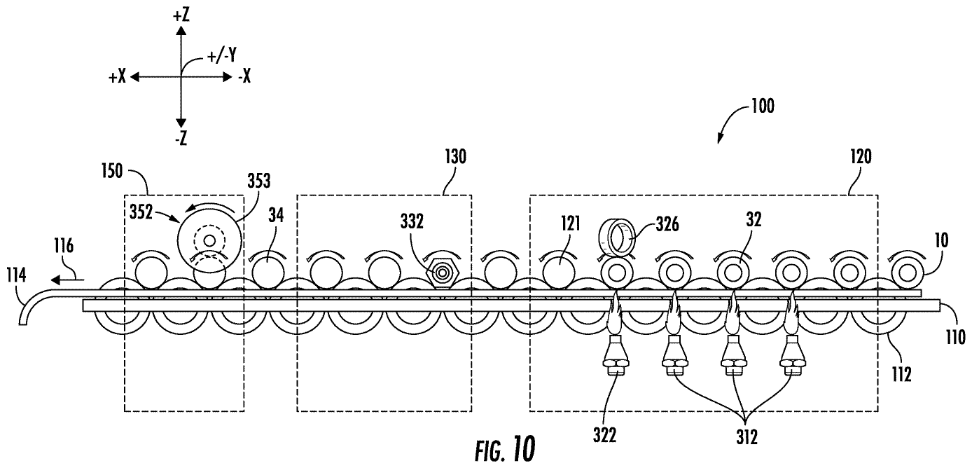

Referring now to FIG. 11, each of the one or more preheating stations 310 may comprise one or more gas burners 312 to heat the target region 50 of the glass tube 10 circumferentially as the conveyor 110 rotates the glass tube 10. The gas burners 312 may be configured to produce a flame and direct it at the hollow cylindrical sidewall 12 in the target region 50, as shown in FIG. 11. In embodiments, the target region 50 may be less than or equal to 200 mm from the starting end 32, less than or equal to 100 mm from the starting end 32, or less than or equal to 50 mm from the starting end 32 (measured from the middle of the target region 50 with respect to the center axis A of the glass tube 10). In embodiments, the target region 50 may be greater than or equal to 25 mm from the starting end 32 of the glass tube 10. In this context, the distance between the target region 50 and the starting end 32 of the glass tube 10 refers to the distance between the middle of the target region, i.e., portion where the heating by gas burner 312 is the greatest, and an end surface 33 of the starting end 32.

The one or more preheating stations 310 may heat the target region 50 of the glass tube 10 to a temperature at which the viscosity of the glass in the target region 50 decreases enough that the glass tube 10 may be separated into two separate pieces by exerting a pulling force on the end of the glass tube 10 in at least an axial direction relative to the center axis A.

Although FIG. 11 depicts a single gas burner 312, it is understood that more than one gas burner 312 may be employed at each of the one or more preheating stations 310. Each gas burner 312 may be fluidly coupled to a fuel supply (not shown), an oxygen supply (not shown), and, optionally, an air supply (not shown). Examples of fuels for the gas burner 312 may include, but are not limited to hydrogen, hydrocarbon fuel gases such as methane, propane, and butane for example, other fuels, or combinations of these. Each gas burner 312 may include a fuel control valve (not shown) to control the flow rate of fuel gas to the gas burner 312. Each gas burner 312 may also include an oxygen control valve (not shown) to control the mass flow rate of oxygen to the gas burner 312. Each gas burner 312 may further include an air control valve (not shown) for optionally controlling a flow rate of air to the gas burner 312. The gas burner 312 may combust the fuel gas in the presence of oxygen and/or air to produce a flame that heats at least the target region 50 of the glass tube 10. The control parameters of the one or more preheating stations 310 may be adjusted depending on the thickness t or outer diameter d₁ of the glass tube 10. Moreover, although the one or more preheating stations 310 of the system 100 are described herein as heating the glass tube 10 using gas burners, it is understood that other heating elements or methods other than gas burners may be used to heat the glass tube 10.

The pulling station 320 of the system 100 includes one or more devices operable to exert a pulling force on an end of each of the glass tubes 10 in at least an axial direction relative to the center axis A of each of the plurality of glass tubes 10. The pulling station 320 may be downstream from the one or more preheating stations 310. Referring now to FIG. 12A, in embodiments, the pulling station 320 may include a gas burner 322, end support rollers 324 configured to support the starting end 32 of the glass tube 10, and at least one separation roller 326 configured to exert an axial pulling force F on the starting end 32 of the glass tube 10, wherein the axial pulling force F separates the annular segment 30 from the glass tube 10.

The gas burner 322 of the pulling station 320 may provide additional heat to the target region 50 to further decrease the viscosity of the target region 50 such that the glass tube 10 may be separated into two separate pieces by exerting a pulling force on the end of the glass tube 10 in at least an axial direction relative to the center axis A.

Although FIG. 12A depicts a single gas burner 322, it is understood that more than one gas burner 322 may be employed at the pulling station 320. Each gas burner 322 may be fluidly coupled to a fuel supply (not shown), an oxygen supply (not shown), and, optionally, an air supply (not shown). Examples of fuels for the gas burner 322 may include, but are not limited to hydrogen, hydrocarbon fuel gases such as methane, propane, and butane for example, other fuels, or combinations of these. Each gas burner 322 may include a fuel control valve (not shown) to control the flow rate of fuel gas to the gas burner 322. Each gas burner 322 may also include an oxygen control valve (not shown) to control the mass flow rate of oxygen to the gas burner 322. Each gas burner 322 may further include an air control valve (not shown) for optionally controlling a flow rate of air to the gas burner 322. The gas burner 322 may combust the fuel gas in the presence of oxygen and/or air to produce a flame that heats at least the target region 50 of the glass tube 10. The control parameters of the pulling station 320 may be adjusted depending on the thickness t or outer diameter d₁ of the glass tube 10. Moreover, although the pulling station 320 of the system 100 is described herein as heating the glass tube 10 using gas burners, it is understood that other heating elements or methods other than gas burners may be used to heat the glass tube 10.

Referring again to FIG. 12A, the end support rollers 324 may operate similarly to the conveying rollers 112. That is, the end support rollers 324 may be arranged side-by-side in the +/−X direction of the coordinate axis in FIG. 12A. In embodiments, the respective axes of rotation of the end support rollers 324 and may extend axially in the +/−Y direction, which may be parallel to the center axis A of the glass tubes 10. The end support rollers 324 may be rotatable in the same rotational direction. Contact of the outer surface 14 of the glass tubes 10 with the surfaces of the end support rollers 324, while the end support rollers 324 are rotated, may rotate the glass tubes 10 about the center axis A of the glass tubes 10 while at the same time providing support to the starting end 32 of the glass tube 10. The relative position of the end support rollers 324 along the length of the glass tube 10 may be adjusted as needed to ensure sufficient support for the separation operation.

With reference still to FIG. 12A, the at least one separation roller 326 may be positioned above the end support rollers 324 such that the glass tube 10 may be positioned therebetween. The glass tube 10 may contact both the end support rollers 324 and the at least one separation roller 326, on generally opposite sides of the glass tube 10. The at least one separation roller 326 may have a roller axis of rotation 326-1 that makes an angle β with the center axis A of the glass tube 10 that is between 10 degrees and 80 degrees, between 20 degrees and 70 degrees, between 30 degrees and 60 degrees, or between 40 degrees and 50 degrees. In embodiments, the angle β between the roller axis of rotation 326-1 and the center axis A of the glass tube 10 is about 45 degrees.

The end support rollers 324 and the at least one separation roller 326 may be configured so as to grip the glass tube 10 therebetween. As the conveyor 110 translates the glass tube through the pulling station 320, the rotation of the at least one separation roller 326 at an angle with respect to the direction 116 in which the glass tubes are conveyed exerts the axial pulling force F on the starting end 32 of the glass tube 10. The magnitude of the axial pulling force F may be adjusted by, for example, modifying the spacing between the end support rollers 324 and the at least one separation roller 326. A decreased spacing between these rollers may tighten the grip the rollers have on the glass tube 10 and the reduced slippage associated with the tightened grip may result in an increased magnitude of the axial pulling force F. In embodiments, the separation roller 326 may be driven.

FIG. 12B depicts the glass tube 10 in the pulling station 320 of the separation station 120 after the annular segment 30 has been separated from the glass tube 10. As discussed above, removing the annular segment 30 of the glass tube 10 concurrently forms a glass meniscus 21 over the new end 34 of the glass tube 10.

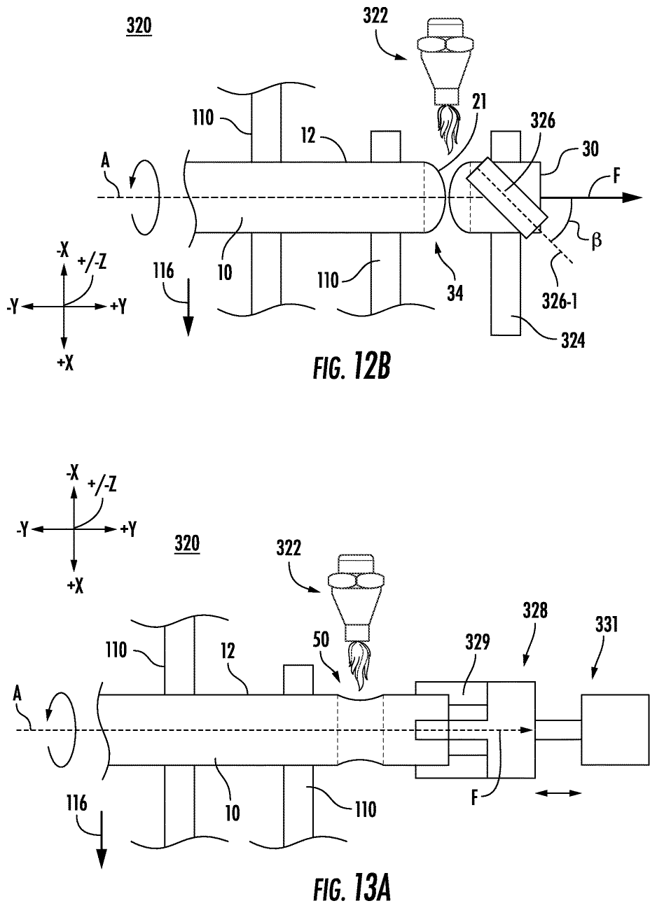

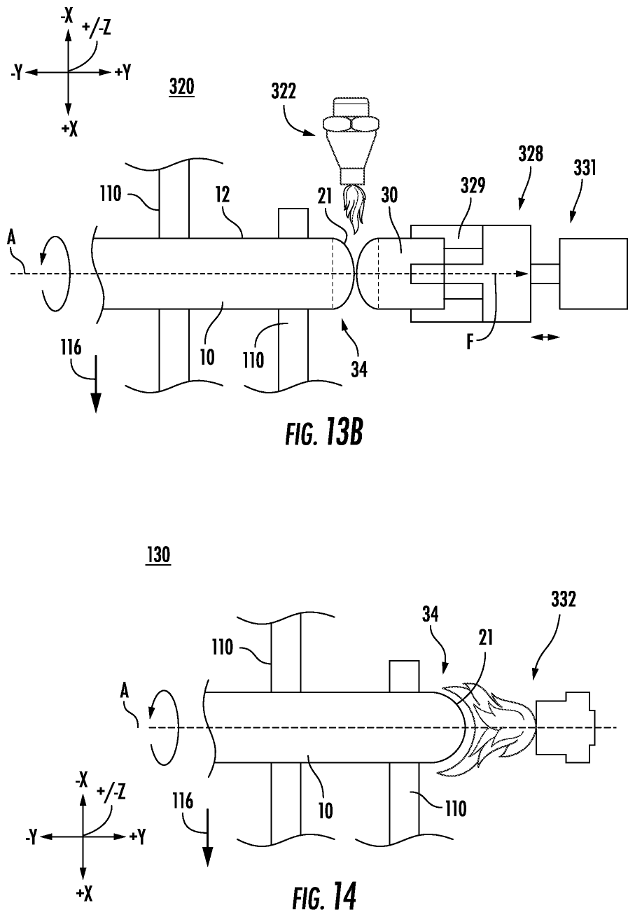

Referring now to FIG. 13A, in embodiments, the pulling station 320 may comprise, as an alternative or in addition to the end support rollers 324 and at least one separation roller 326, a gripper configured to grasp and exert the axial pulling force F on the starting end 32 of the glass tube 10, wherein the axial pulling force F separates the annular segment 30 from the glass tube 10. In the embodiment shown in FIG. 13A, the gripper is a three-finger chuck 328 that is configured to grasp the starting end 32 of the glass tube 10 with fingers 329 and to move away from the glass tube 10 along the center axis A of the glass tube 10 to exert the axial pulling force F on the starting end 32 of the glass tube 10. The fingers 329 of the three-finger chuck 328 may be a high-temperature plastic material, such as a polyimide material. The three-finger chuck 328 may be supported by a piston 331 configured to move the three-finger chuck to and away from the glass tube 10. The three-finger chuck 328 may also be rotatable about its center axis and/or be translatable along the machine direction 116 of the conveyor 110.

FIG. 13B depicts the glass tube 10 in the pulling station 320 of the separation station 120 after the annular segment 30 has been separated from the glass tube 10 by the three-finger chuck 328, e.g., via a retraction of the piston 331. It should be understood that the three-finger chuck 328 is merely one form of a gripper capable of exerting the axial pulling force F on the starting end 32 of the glass tube 10 to separate the annular segment 30 from the glass tube 10. Utilizing the gripper option at the pulling station 320 may provide the separation process with flexibility that may be advantageous given that glass tubes 10 used as starting materials in the glass packaging industry have a wide range of outer diameters d₁.

As discussed above, the polishing station 130 may be operable to shape the meniscus of glass 21 at the new end 34 of the glass tube 10 to form the dome end glaze 20 having the desired radius of curvature at the new end 34 of the glass tube 10. As shown in FIG. 10, the polishing station 130 may be downstream from the separating station 120. Referring now to FIG. 14, the polishing station 130 may comprise a gas burner 332, e.g., a fire-polishing torch, configured to flame polish the glass meniscus 21 at the new end 34 of the glass tube 10.

The final convex shape of the outer surface 24 of the dome end glaze 20 may be modified by exposing the glass meniscus 21 to the flame of the gas burner 332. As the flame of the gas burner 332 heats up the glass meniscus 21, the molten glass forming the glass meniscus 21 will become less viscous and surface tension will drive the reshaping of the glass meniscus 21 and corresponding convex shape of the dome end glaze 20.

In embodiments, the polishing station 130 may be configured to modify the shape of the glass meniscus 21 such that the outer surface 24 of the resulting dome end glaze 20 comprises a convex shape having a radius of curvature r_{c} greater than or equal to 0.4 times d₁ over positions on the convex shape that are within a distance of 0.4 times d₁ from the center axis A of the glass tube 10. In embodiments, the polishing station 130 may be configured to modify the shape of the glass meniscus 21 such that the outer surface 24 of the resulting dome end glaze 20 comprises a convex shape having a radius of curvature r_{c} of about 0.5 times d₁ over positions on the convex shape that are within a distance of 0.4 times d₁ from the center axis A of the glass tube 10. In embodiments, the polishing station 130 may be configured to modify the shape of the glass meniscus 21 such that the outer surface 24 of the resulting dome end glaze 20 comprises a convex shape having a radius of curvature r_{c} greater than or equal to 0.4 times d₁ and less than or equal to 0.6 times d₁ over positions on the convex shape that are within a distance of 0.4 times d₁ from the center axis A of the glass tube 10. In embodiments, the polishing station 130 may be configured to modify the shape of the glass meniscus 21 such that the outer surface 24 of the resulting dome end glaze 20 comprises a convex shape having a radius of curvature r_{c} greater than or equal to 0.3 times d₁ and less than or equal to 0.7 times d₁ over positions on the convex shape that are within a distance of 0.4 times d₁ from the center axis A of the glass tube 10. In embodiments, the polishing station 130 may be configured to modify the shape of the glass meniscus 21 such that the outer surface 24 of the resulting dome end glaze 20 comprises a convex shape having a radius of curvature r_{c} greater than or equal to 0.45 times d₁ and less than or equal to 0.55 times d₁ over positions on the convex shape that are within a distance of 0.4 times d₁ from the center axis A of the glass tube 10.

Although FIG. 14 depicts a single gas burner 332, it is understood that more than one gas burner 332 may be employed at the polishing station 130. Each gas burner 332 may be fluidly coupled to a fuel supply (not shown), an oxygen supply (not shown), and, optionally, an air supply (not shown). Examples of fuels for the gas burner 332 may include, but are not limited to hydrogen, hydrocarbon fuel gases such as methane, propane, and butane for example, other fuels, or combinations of these. Each gas burner 332 may include a fuel control valve (not shown) to control the flow rate of fuel gas to the gas burner 332. Each gas burner 332 may also include an oxygen control valve (not shown) to control the mass flow rate of oxygen to the gas burner 332. Each gas burner 332 may further include an air control valve (not shown) for optionally controlling a flow rate of air to the gas burner 332. The gas burner 332 may combust the fuel gas in the presence of oxygen and/or air to produce a flame for heating the glass meniscus 21. The control parameters of the polishing station 130 may be adjusted depending on the thickness t or outer diameter d₁ of the glass tube 10.

As previously discussed, the processes disclosed herein for finishing the ends of the glass tubes to produce the dome end glaze may reduce the amount of defects in the glass and reduce deposition of fused glass particles on the surfaces of the glass tubes compared to the conventional end finishing processes.

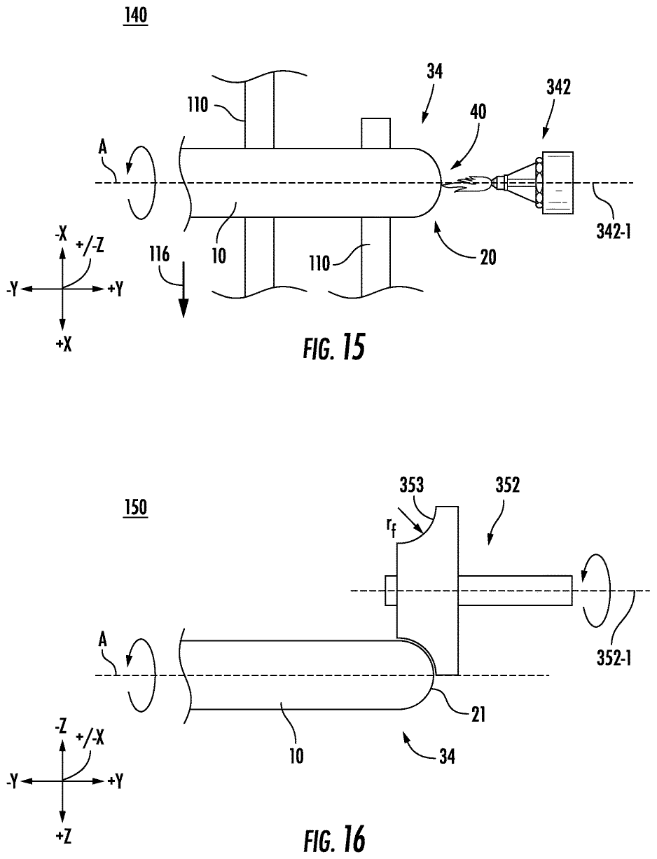

In embodiments, the system 100 may include a vent hole station 140 positioned downstream from the polishing station 130. The vent hole station 140 may be operable to form a vent hole 40 in the dome end glaze 20. With reference to FIG. 15, in embodiments, the vent hole station 140 may comprise a vent hole burner 342 configured to form the vent hole 40 in the dome end glaze 20. In embodiments, the vent hold burner 342 may be a pencil burner having a focused flame with a narrow heating area. The vent hole burner 342 may be positioned so as to orient a flame produced by the vent hole burner 342 at a particular region of the dome end glaze 20. In the embodiment shown in FIG. 15, an axis 342-1 of the vent hole burner 342 is substantially aligned with the center axis A of a glass tube 10 such that the center line CL of the resulting vent hole 40 is substantially aligned with the center axis A. In other embodiments, the axis 342-1 of the vent hole burner 342 may form an angle (not shown) with the center axis A of the glass tube 10 such that the center line CL of the vent hole 40 makes an angle α with the center axis A of the glass tube 10 that is about 45 degrees. In embodiments, the axis 342-1 of the vent hole burner 342 may form an angle (not shown) with the center axis A of the glass tube 10 such that the center line CL of the vent hole 40 makes an angle α with the center axis A of the glass tube 10 that is less than 80 degrees, less than 70 degrees, or less than 45 degrees. In embodiments, the axis 342-1 of the vent hole burner 342 may form an angle (not shown) with the center axis A of the glass tube 10 such that the center line CL of the vent hole 40 is not perpendicular with the center axis A of the glass tube 10.

The vent hole burner 342 may be fluidly coupled to one or more of a fuel gas supply (not shown), oxygen supply (not shown), air supply (not shown), or combinations of these. Examples of fuels for the vent hole burner 342 may include, but are not limited to hydrogen, hydrocarbon fuel gases such as methane, propane, and butane for example, other fuels, or combinations of these. The vent hole burner 342 may include a fuel control valve (not shown) to control the flow rate of fuel gas to the vent hole burner 342. The vent hole burner 342 may also include an oxygen control valve (not shown) to control the mass flow rate of oxygen to the vent hole burner 342. The vent hole burner 342 may further include an air control valve (not shown) for optionally controlling a flow rate of air to the vent hole burner 342. The vent hole burner 342 may combust the fuel gas in the presence of oxygen and/or air to produce a flame for melting and opening the dome end glaze 20 to form the vent hole 40. The control parameters of the vent hole station 140 may be adjusted depending on the thickness t_{d} of the dome end glaze 20.

In embodiments, the vent hole burner 342 may have a heating area sufficient to produce a vent hole 40 having a diameter Dᵥ between 0.01 times d₁ and 0.25 times d₁, between 0.05 times d₁ and 0.20 times d₁, or between 0.10 times d₁ and 0.20 times d₁. In embodiments, the vent hole burner 342 may have a heating area sufficient to produce a vent hole 40 having a diameter Dᵥ between 1 mm and 5 mm or between 2 mm and 4 mm. In embodiments, the vent hole burner 342 may have a heating area sufficient to produce a vent hole 40 having a diameter Dᵥ of 3 mm. Following formation of the vent hole 40, dome end glaze 20 may cover at least 40%, at least 45%, at least 50%, at least 55%, at least 60%, at least 65%, at least 70%, at least 70%, at least 75%, at least 80%, at least 85%, at least 90%, at least 95%, or at least 98% of a cross-sectional area of the glass tube 10. For example, a glass tube 10 having a 16.00 mm outer diameter d₁ and a dome end glaze 20 with the vent hole 40 having a diameter Dᵥ of 3.0 mm, the cross-sectional area of the glass tube 10 would be 201.1 mm² and the cross-sectional area of the vent hole would be 7.1mm², making the dome end glaze 20 cover approximately 96.5% of the cross-sectional area of the glass tube 10.

Referring again to FIG. 10, in embodiments, the system 100 may include a forming station 150 positioned downstream from the polishing station 130. The forming station 150 may be operable to the reshape the glass meniscus 21 so as to modify the shape of the resulting dome end glaze 20. With reference to FIG. 16, the forming station 150 may comprise a forming tool 352 operable to deform molten glass. The forming tool 352 may be rotatable about a tooling axis 352-1. In embodiments, the tooling axis 352-1 of the forming tool 352 may be parallel to the center axis A of the glass tube 10. The forming tool 352 may have a forming feature 353 designed to achieve a desired shape of the glass meniscus 21. The forming feature 353 may have a radius of curvature r_{c} selected based on the desired radius of curvature r_{c} of the dome end glaze 20. In embodiments, the forming feature 353 may be configured to produce a tapered region of the dome end glaze 20, as discussed in more detail above. In embodiments of the system 100 including the vent hole station 140, the forming station 150 may be positioned upstream from the vent hole station 140.

In embodiments, the system 100 may be configured to finish both the first end 17 and the second end 18 of the glass tube 10. In such embodiments, the separation station 120 may be configured to: (i) remove a first annular segment of the glass tube from a first starting end of the glass tube, wherein removing the first annular segment from the first starting end of the glass tube forms a first meniscus of glass over a first new end of the glass tube; and (ii) remove a second annular segment of the glass tube from a second starting end of the glass tube, wherein removing the second annular segment from the second starting end of the glass tube forms a second meniscus of glass over a second new end of the glass tube. The polishing station 130 may be configured to: (i) polish the first meniscus of glass and the first new end of the glass tube to form a first dome end glaze at the first new end of the glass tube; and (ii) polish the second meniscus of glass and the second new end of the glass tube to form a second dome end glaze at the second new end of the glass tube. The resulting glass tube 10 comprises a first dome end glaze with a first outer surface having a first convex shape and a second dome end glaze having a second outer surface with a second convex shape.

In embodiments wherein the system 100 is configured to finish both the first end 17 and second end 18 of the glass tube 10, the subsystems of the system 100, e.g., the separating station 120 and the polishing station 130, may be configured in the same manner as discussed herein and shown in the present drawings. As discussed above, it is believed that glass tubes 10 having dome-shaped ends at both ends will be particularly useful in pharmaceutical packaging applications where tube cleanliness is of increased importance.

Methods for producing glass tubes 10 using systems 100 disclosed herein will now be described in further detail. Referring again to FIG. 10, methods of the present disclosure for finishing one or more ends of a glass tube 10 include rotating the glass tube 10 about the center axis A, removing the annular segment 30 of the glass tube 10 from the starting end 32 of the glass tube 10, wherein removing the annular segment 30 from the starting end 32 of the glass tube 10 forms the glass meniscus 21 over the new end 34 of the glass tube 10, and polishing the glass meniscus 21 at the new end 34 of the glass tube 10 to form the dome end glaze 20 at the new end 34 of the glass tube 10. Moreover, the methods disclosed herein for finishing one or both ends of glass tubes 10 may be used to produce glass tubes 10 comprising a longitudinal length L that may be greater than or equal to 30 times d₁. In embodiments, the methods disclosed herein may be used to finish one or both ends of glass tubes having a longitudinal length L greater than or equal to 800 mm.

The methods disclosed herein for finishing one or both ends of the glass tube 10 may include, prior to rotating the glass tube 10 about the center axis A, receiving the glass tube 10 from a tube manufacturing process, e.g., system 200 described above and shown in FIGS. 8 and 9.

Referring now to FIG. 10, rotating the glass tube 10 about the center axis A may comprise translating the glass tube 10 horizontally in the machine direction 116 of the conveyor 110 (i.e, in the +X direction of the coordinate axis in FIG. 10 (perpendicular to the center axis A of the glass tubes 10)) while also rotating the glass tube 10 about the center axis A of the glass tube 10. Contact of the outer surface 14 of the glass tube 10 with the surfaces of the conveying rollers 112, while the conveying rollers 112 are rotated, may rotate the glass tube 10 about the center axis A of the glass tube 10. The method may comprise translating the glass tube 10 through the separating station 120 and the polishing station 130 via the conveyor 110.

Referring again to FIGS. 11-13B, removing the annular segment 30 from the starting end 32 of the glass tube 10 may comprise heating the target region 50 of the glass tube 10 proximate the starting end 32 and conveying the annular segment 30 of the glass tube 10 away from the glass tube 10 in a direction parallel to the center axis A of the glass tube 10. With reference to FIG. 11, heating the target region 50 of the glass tube 10 may comprise heating the glass tube 10 circumferentially as the glass tube 10 rotates using the gas burner 312. As discussed above with respect to the system 100, the target region 50 may be less than or equal to 200 mm, less than or equal to 100 mm, or less than or equal to 50 mm from the starting end 32 of the glass tube 10. In embodiments, the target region 50 may be greater than or equal to 25 mm from the starting end 32 of the glass tube 10.

With reference now to FIGS. 12A and 12B, conveying the annular segment 30 of the glass tube 10 away from the glass tube 10 may comprise contacting the starting end 32 of the glass tube 10 with at least one separation roller 326 having a roller axis of rotation 326-1 that makes an angle B with the center axis A of the glass tube 10 that is between 10 degrees and 80 degrees. Moreover, contacting the starting end 32 of the glass tube 10 with the at least one separation roller 326 may exert an axial pulling force F on the starting end 32 of the glass tube 10, and the axial pulling force F may separate the annular segment 30 from the glass tube 10. During the conveying of the annular segment 30 away from the glass tube 10, the method may comprise heating the target region 50 with the gas burner 322 to further reduce the viscosity of the target region 50 such that the axial pulling force F is sufficient to separate the annular segment 30 from the glass tube 10. When the annular segment 30 is separated from the glass tube 10, the glass meniscus 21 forms over the new end 34 of the glass tube 10.

Referring again to FIG. 14, polishing the glass meniscus 21 at the new end 34 of the glass tube 10 may comprise exposing the glass meniscus 21 at the new end 34 of the glass tube 10 to the gas burner 332 to flame polish the glass meniscus 21 at the new end 34 of the glass tube 10. In embodiments, polishing the glass meniscus 21 may modify the shape of the glass meniscus 21 such that the outer surface 24 of the resulting dome end glaze 20 comprises a convex shape having a radius of curvature r_{c} greater than or equal to 0.4 times d₁ over positions on the convex shape that are within a distance of 0.4 times d₁ from the center axis A of the glass tube 10.

In embodiments, polishing the glass meniscus 21 may modify the shape of the glass meniscus 21 such that the outer surface 24 of the resulting dome end glaze 20 comprises a convex shape having a radius of curvature r_{c} of about 0.5 times d₁ over positions on the convex shape that are within a distance of 0.4 times d₁ from the center axis A of the glass tube 10. In embodiments, polishing the glass meniscus 21 may modify the shape of the glass meniscus 21 such that the outer surface 24 of the resulting dome end glaze 20 comprises a convex shape having a radius of curvature r_{c} greater than or equal to 0.4 times d₁ and less than or equal to 0.6 times d₁ over positions on the convex shape that are within a distance of 0.4 times d₁ from the center axis A of the glass tube 10. In embodiments, polishing the glass meniscus 21 may modify the shape of the glass meniscus 21 such that the outer surface 24 of the resulting dome end glaze 20 comprises a convex shape having a radius of curvature r_{c} greater than or equal to 0.3 times d₁ and less than or equal to 0.7 times d₁ over positions on the convex shape that are within a distance of 0.4 times d₁ from the center axis A of the glass tube 10.

Referring now to FIG. 15, the methods for finishing one or more ends of a glass tube 10 may include forming the vent hole 40 in the dome end glaze 20. Forming the vent hole 40 may comprise melting and opening the dome end glaze 20 at a position aligned with the center axis A of the glass tube 10. The melting and opening of the dome end glaze 20 may comprise exposing the dome end glaze 20 to the vent hole burner 342, in particular, the flame produced by the vent hole burner 342.

Referring now to FIG. 16, the methods for finishing one or more ends of a glass tube 10 may include forming the glass meniscus 21 to modify the shape of the resulting dome end glaze 20. Forming the glass meniscus 21 may comprise contacting the glass meniscus 21 with a forming tool 352 that reshapes the glass meniscus 21.

As discussed above with respect to systems 100, the methods disclosed herein may comprise finishing the first end 17 and the second end 18 of the glass tube 10. In such embodiments, the method includes: (i) removing the first annular segment of the glass tube 10 from a first starting end of the glass tube, wherein removing the first annular segment from the first starting end of the glass tube forms the first meniscus of glass over the first new end of the glass tube; and (ii) removing the second annular segment of the glass tube 10 from the second starting end of the glass tube, wherein removing the second annular segment from the second starting end of the glass tube 10 forms a second meniscus of glass over the second new end of the glass tube. The method may further comprise: (i) polishing the first meniscus of glass and the first new end of the glass tube to form the first dome end glaze at the first new end of the glass tube; and (ii) polishing the second meniscus of glass and the second new end of the glass tube to form the second dome end glaze at the second new end of the glass tube. The resulting glass tube 10 comprises a first dome end glaze with a first outer surface having a first convex shape and a second dome end glaze having a second outer surface with a second convex shape.

The glass tubes 10 and corresponding systems 100 and methods disclosed herein provide a combination of valuable benefits to entities in the pharmaceutical packaging industry. On the tube manufacturing side, the systems 100 and methods disclosed herein offer improved manufacturing efficiency at least in part based on the avoidance of the conventional final cut-to-length operation and associated processes, as discussed above. For entities on the converting side, the glass tubes 10 with dome-shaped ends disclosed herein offer a reduction in tube damage associated with typical shipping and handling operations, improved converting performance as a result of the reduced tube damage, and glass particulate mitigation in the stock glass tubing which may improve the quality of the converted glass articles.

While various embodiments of the systems 100 and methods for finishing the ends of the glass tubes 10 using the systems 100 have been described herein, it should be understood that it is contemplated that each of these embodiments and techniques may be used separately or in conjunction with one or more embodiments and techniques.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A glass tube comprising:
a first end and a second end; and
a hollow cylindrical sidewall comprising a glass and having an outer diameter d₁, wherein:
the first end, the second end, or both comprise a dome end glaze comprising the glass and having an outer surface with a convex shape, wherein the convex shape of the outer surface of the dome end glaze comprises a radius of curvature r_{c} greater than or equal to 0.4 times d₁ over positions on the convex shape that are within a distance of 0.4 times d₁ from a center axis of the glass tube, and a dome height H greater than or equal to 0.4 times d₁; and
the glass tube comprises a longitudinal length L greater than or equal to 30 times d₁.

2. The glass tube of claim 1, wherein the longitudinal length L of the glass tube is greater than or equal to 800 mm.

3. (canceled)

4. The glass tube of claim 1, wherein the radius of curvature r_{c} is less than or equal to 0.6 times d₁ over positions on the convex shape that are within a distance of 0.4 times d₁ from the center axis of the glass tube.

5. (canceled)

6. The glass tube of claim 1, wherein the dome height H is less than or equal to 0.6 times d₁.

7. The glass tube of claim 1, wherein the dome end glaze comprises a wall thickness that is less than or equal to a wall thickness of the hollow cylindrical sidewall.

8. The glass tube of claim 1, wherein the dome end glaze covers at least 75% of a cross-sectional area of the glass tube at the first end, the second end, or both.

9. The glass tube of claim 8, wherein the dome end glaze closes off the glass tube at the first end of the glass tube, the second end of the glass tube, or both.

10. The glass tube of claim 8, wherein the dome end glaze comprises a vent hole, wherein the vent hole comprises a diameter of between 0.05 times d₁ and 0.20 times d₁.

11. The glass tube of claim 10, wherein the vent hole is aligned with a center axis of the glass tube.

12. The glass tube of claim 10, wherein a center line of the vent hole makes an angle with a center axis of the glass tube that is less than 90 degrees, less than 70 degrees, or less than 45 degrees.

13. The glass tube of claim 10, wherein a center line of the vent hole is not perpendicular to a center axis of the glass tube.

14. (canceled)

15. The glass tube of claim 1, wherein the glass tube is substantially free of end cracks and inclusions.

16. The glass tube of claim 1, wherein the glass tube is substantially free of glass particulates fused to outer surfaces and inner surfaces of the hollow cylindrical sidewall.

17. The glass tube of claim 1, wherein the dome end glaze comprises a first dome end glaze at the first end of the glass tube and a second dome end glaze at the second end of the glass tube.

18. A method of finishing an end of a glass tube, the method comprising:
rotating the glass tube about a center axis of the glass tube;
removing an annular segment of the glass tube from a starting end of the glass tube, wherein removing the annular segment from the starting end of the glass tube forms a meniscus of glass over a new end of the glass tube;
wherein the glass tube comprises a longitudinal length L greater than or equal to 30 times d₁, where d₁ is an outer diameter of the glass tube; and
polishing the meniscus of glass at the new end of the glass tube to form a dome end glaze at the new end of the glass tube, wherein the dome end glaze comprises an outer surface having a convex shape, wherein the convex shape of the outer surface of the dome end glaze comprises a radius of curvature r_{c} greater than or equal to 0.4 times d₁ over positions on the convex shape that are within a distance of 0.4 times d₁ from the center axis of the glass tube, and a dome height H greater than or equal to 0.4 times d₁.

19. The method of claim 18, wherein the longitudinal length L of the glass tube is greater than or equal to 800 mm.

20. (canceled)

21. The method of claim 18, wherein the radius of curvature r_{c} is less than or equal to 0.6 times d₁ over positions on the convex shape that are within a distance of 0.4 times d₁ from the center axis of the glass tube.

22. (canceled)

23. The method of claim 18, wherein the dome height H is less than or equal to 0.6 times d₁.

24. The method of claim 18, wherein removing the annular segment from the starting end of the glass tube comprises:
heating a target region of the glass tube proximate the starting end of the glass tube; and
conveying the annular segment of the glass tube away from the glass tube in a direction parallel to the center axis of the glass tube.

25. The method of claim 24, wherein heating the target region of the glass tube comprises heating the glass tube circumferentially as the glass tube rotates, and wherein the target region less than or equal to 50 mm from the starting end of the glass tube.

26. The method of claim 24, wherein conveying the annular segment of the glass tube away from the glass tube comprises contacting the starting end of the glass tube with a roller having a roller axis of rotation that makes an angle with the center axis of the glass tube that is between 10 degrees and 80 degrees, wherein contacting the starting end of the glass tube with the roller exerts an axial pulling force on the starting end of the glass tube, and wherein the axial pulling force separates the annular segment from the glass tube.

27. The method of claim 18, wherein polishing the meniscus of glass at the new end of the glass tube comprises exposing the meniscus of glass at the new end of the glass tube to a gas burner to flame polish the meniscus of glass at the new end of the glass tube.

28. (canceled)

29. (canceled)

30. The method of claim 18, further comprising forming a vent hole in the dome end glaze.

31. The method of claim 30, wherein forming the vent hole in the dome end glaze comprises opening the dome end glaze at a position aligned with the center axis of the glass tube.

32. The method of claim 30, wherein forming the vent hole in the dome end glaze comprises exposing the dome end glaze to a vent hole burner to melt and open the dome end glaze.

33. The method of claim 18, further comprising forming the meniscus to modify the convex shape of the dome end glaze.

34. The method of claim 33, wherein forming the meniscus comprises contacting the meniscus with a forming tool that reshapes the meniscus.

35. The method of claim 18, wherein the method comprises finishing a first and a second end of the glass tube by:
removing a first annular segment of the glass tube from a first starting end of the glass tube, wherein removing the first annular segment from the first starting end of the glass tube forms a first meniscus of glass over a first new end of the glass tube;
polishing the first meniscus of glass and the first new end of the glass tube to form a first dome end glaze at the first new end of the glass tube;
removing a second annular segment of the glass tube from a second starting end of the glass tube, wherein removing the second annular segment from the second starting end of the glass tube forms a second meniscus of glass over a second new end of the glass tube; and
polishing the second meniscus of glass and the second new end of the glass tube to form a second dome end glaze at the second new end of the glass tube,
wherein the first dome end glaze comprises a first outer surface having a first convex shape and the second dome end glaze comprises a second outer surface having a second convex shape.

36. The method of claim 18, wherein prior to rotating the glass tube about the center axis of the glass tube, the method further comprises:
receiving the glass tube from a tube manufacturing process.

37-57. (canceled)
